(19) United States
(12) Patent Application Publication
(10) Pub. No.: US 2015/0153725 A1
(43) Pub. Date: Jun. 4, 2015

(54) SYSTEM AND METHOD FOR BATCH CONTROL PROCESSING

(71) Applicant: ECS SOLUTIONS INC., Evansville, IN (US)

(72) Inventors: Timothy Matheny, Evansville, IN (US); Phillip Michel, Huntingburg, IN (US); Randy Otto, Haubstadt, IN (US)

(21) Appl. No.: 14/357,504

(22) PCT Filed: Nov. 13, 2012
(86) PCT No.: PCT/US12/64862

§ 371 Date: May 9, 2014

Related U.S. Application Data
(60) Provisional application No. 61/558,756, filed on Nov. 11, 2011.

(51) Int. Cl. G05B 19/4155

(52) U.S. Cl. CPC G05B 19/4155; G05B 2219/32077

(57) ABSTRACT

A system and method for batch control processing includes at least one controller having instructions and database. The database includes information relating to instruments, control modules, and equipment modules and the instructions pull information from the database to control the system and process, a manufacturing facility is provided that manipulates materials to form products. The facility includes a plurality of components that manipulate or measure the material and at least one controller having instructions and at least one database. The database includes information grouping the plurality of components into task oriented groups, referred to as equipment modules. When the facility requires the completion of tasks, the instructions in the controllers pull information from the database regarding which facility components are required to complete the particular task. For each new task request, the instructions pull information from the database regarding which facility components are required to complete the new task.

### RELATED APPLICATIONS

This application claims priority to U.S. Provisional Patent Application Ser. No. 61/558,756, filed Nov. 11, 2011, titled “SYSTEM AND METHOD FOR BATCH CONTROL PROCESSING” to Timothy Matheny et al., the entire disclosure of which is expressly incorporated by reference herein.

### TECHNICAL FIELD

The present disclosure relates to controlling manufacturing processes. More particularly, the present disclosure relates to systems and processes for configuring control of components of the manufacturing facility using controllers.

### BACKGROUND AND SUMMARY

Batch control processing allows an operator to define a recipe, and then control various valves, pumps, tanks, and other machinery to move material from one place to another. The overall recipe may be, for example, to create a processed food product, and the recipe may include several steps to create the product. The steps may require the operation of one or more pieces of machinery to move product or to use machinery to accomplish a task.

Batch control systems based on the S88 Batch Standard provide benefits to an end user, such as increased quality and throughput and decreased cost. In order to develop the software for an S88 control system, an operator or other user develops procedures, called recipes, to define the end-users process used to create their particular product. The recipes work in conjunction with an S88 Equipment Model that provides the overall architecture of the hardware available in the system. The S88 Equipment Model connects via “phases” to the hardware controller. The controller takes direct control of all of the field devices, such as motors, valves, and other instrumentation associated with the system. The S88 model defines this control as “control modules” and “equipment modules.”

Typical batch managing software products on the market, such as FactoryTalk Batch sold by Rockwell Automation, provide a way to configure the process cell, unit, and equipment phases of the S88 Batch Standard, providing benefits to end users and developers. However, control and equipment modules are still programmed directly in the controller and/or through the human-machine interface (“HMI”) to the controller, which involves a significant amount of effort. The effort includes time spent programming, time spent simulating the recipe, and time spent commissioning the recipe.

According to the present invention, a manufacturing facility is provided that manipulates materials to form products. The facility includes a plurality of components that manipulate or measure the material and at least one controller having instructions and at least one database. The database includes information grouping the plurality of components into task oriented groups, referred to as equipment modules. When the facility requires the completion of a specific task, the instructions in the controller(s) pull information from the database regarding which facility components are required to complete the particular task. For each new task request, the instructions pull information from the database regarding which facility components are required to complete the new task. For each unique task, the combination of information pulled for each task will be unique. As a result, the instructions will control a different group of facility components for each unique task or may control groups of facility components in a unique way.

The present invention also includes processes for designing a manufacturing facility, configuring the control of the facility, controlling the manufacturing facility, etc. using a controller with instructions and a database. Furthermore, the present invention includes processes for initially populating the database and modifying a database, including modifications while production lines of the facility controlled by the controller with the database are still operating to form products from the materials.

To facilitate interaction between the manufacturing facility and users, the present invention includes human-machine interfaces. The human-machine interfaces include data pulled from the database stored in the controller.

According to one aspect of the present invention, a batch process manufacturing facility is provided. The facility includes a plurality of units containing different materials that when combined form products, a plurality of instruments positioned to measure characteristics of the different materials, a plurality of control modules positioned to control the manipulation of the materials, a plurality of equipment modules having an equipment module identifier, and at least one automation controller including at least one database and instructions. Each of the plurality of instruments has an instrument identifier and each control module has a control module identifier. The at least one database includes the instrument identifiers, control module identifiers, and equipment module identifiers. The at least one automation controller receives a request to manipulate a material. Based on the request, the instructions pull from the at least one database a subset of the instrument identifiers and control module identifiers associated with at least one equipment module identifier to define one of the plurality of equipment modules to include a subset of the plurality of instruments and control modules to manipulate the material.

According to another aspect of the present invention, a method of configuring a control system for a batch manufacturing facility is provided. The method includes the steps of providing a batch manufacturing facility design including a plurality of source units configured to contain different materials that when combined form products, a plurality of instruments configured to measure characteristics of the different materials, and a plurality of control modules configured to control the manipulation of the materials, populating a database with identifiers for the plurality of instruments and the plurality of control modules, populating the database with a plurality of equipment modules, each equipment module including at least one of the identifiers, providing at least one automation controller configured to communicate with a plurality of instruments and a plurality of control modules of a batch manufacturing facility, and placing the database and instructions in at least one automation controller. The instructions are configured to act upon requests to manipulate the materials, pull identifiers from the database, receive information from any of the plurality of instruments identified from the identifiers pulled from the database, and control any of the plurality of control modules identified from the identifiers pulled from the database to manipulate the materials.

According to another aspect of the present invention, a method of controlling a batch manufacturing facility is provided. The method includes providing a batch manufacturing facility including a plurality of units containing different materials that when combined form products, a plurality of instruments positioned to measure characteristics of the different materials, each of the plurality of instruments having an instrument identifier, a plurality of control modules positioned to control the manipulation of the materials, each control module having a control module identifier, and at least one automation controller including at least one database, the at least one database including the instrument identifiers and control module identifiers. The method further includes receiving a request for one of the equipment modules to manipulate the materials, pulling data from the at least one database including a subset of instrument identifiers and control module identifiers, controlling control modules identified in the pulling step to manipulate materials, receiving data from instruments identified in the pulling data step, and controlling control modules identified in the pulling step to cease manipulation of the materials based on data received during the receiving data step.

According to another aspect of the present inventions, a method of configuring a control system for a batch manufacturing facility is provided. The method includes the steps of providing a batch manufacturing facility design including a plurality of facility components including a plurality of source units configured to contain different materials that when combined form products, a plurality of instruments configured to measure characteristics of the different materials, a plurality of control modules configured to control the manipulation of the materials, and a plurality of destination units configured to contain materials from source units. The method further includes providing a plurality of graphical symbols of the facility components, populating a graphical display with a plurality of the graphical symbols to represent the facility components of the batch manufacturing facility design, populating at least one database with unique identifiers for the plurality of graphical symbols representing the facility components, establishing connections between source units, control modules, and destination units, graphically displaying the established connections between source units, control modules, and destination units, populating the at least one database with the established connections between the sources units, control modules, and destination units using the unique identifiers, and populating the at least one database with equipment modules including at least one unique identifier configured to manipulate the material.

According to another aspect of the present invention, a method of providing graphical user interfaces for a batch manufacturing facility is provided. The method includes the steps of providing a batch manufacturing facility including facility components including a plurality of source units containing different materials that when combined form products, a plurality of instruments positioned to measure characteristics of the different materials, each of the plurality of instruments having an instrument identifier, a plurality of control modules positioned to control the manipulation of the materials, each control module having a control module identifier, and at least one automation controller including at least one database containing identifiers for a plurality of facility components. The method further includes providing a plurality of graphical user interface templates for the source units, instruments, and control modules, the graphical user interface templates including a plurality of data fields, selecting at least one of the facility components and a group of associated facility components, pulling data from the at least one database based on the identifier of the selected facility component, selecting one of the graphical user interface templates based on the selected facility component, populating the plurality of data fields of the selected graphical user interface template using data pulled from the at least one database, and displaying the selected graphical user interface template with the populated plurality of data fields.

According to another aspect of the present invention, a batch process manufacturing facility is provided. The facility includes a plurality of units containing different materials that when combined form products, a plurality of instruments positioned to measure characteristics of the different materials, each of the plurality of instruments having an instrument identifier, a plurality of control modules positioned to control the manipulation of the materials, each control module having a control module identifier, a plurality of equipment modules having an equipment module identifier, and at least one controller including at least one database and instructions including compiled code. The at least one database includes the instrument identifiers, control module identifiers, and equipment module identifiers, and non-complied code. The at least one controller receives a request to manipulate a material. Wherein based on the request, the compiled code of the instructions pull from the at least one database non-compiled code and interprets the non-compiled code to manipulate the material.

### BRIEF DESCRIPTION OF THE DRAWINGS

The foregoing aspects and many of the attendant features of the present disclosure will become more readily appreciated as the same become better understood by reference to the following detailed description when taken in conjunction with the accompanying drawings.

FIG. 1 is a diagrammatic view of a plant, such as a food processing plant, showing exemplary sets of control modules (“CM's”), such as valves, pumps, etc., and a plurality of equipment modules (“EM's”) shown in phantom, which consists of one or more control modules.

FIG. 2 is a diagrammatic view of a plant control system that operates CM's and EM's of FIG. 1.

FIG. 3 is a diagrammatic view of a component control system that controls the CM's and EM's of FIG. 1.

FIG. 4 is a more detailed view of the component control system of FIG. 3.

FIG. 5 is an exemplary method for creating data for a configuration database according to an embodiment of the present disclosure.

FIG. 6 is an exemplary method for populating the configuration database with data for units (tanks, cook kettles, etc.); instruments (sensors, meters, etc.); CM's; and EM's that include collections of units, instruments, CM′, and other EM's.

FIG. 7 is an exemplary screen showing a portion of a pre-defined unit class table according to an embodiment of the present disclosure.

FIG. 8 is an exemplary screen showing a portion of a unit table according to an embodiment of the present disclosure.

FIG. 9 is an exemplary screen showing a pre-defined instrument class table according to an embodiment of the present disclosure.

FIG. 10 is an exemplary screen showing a portion of an instrument table according to an embodiment of the present disclosure.

FIG. 11 is an exemplary screen showing a portion of a pre-defined CM class table according to an embodiment of the present disclosure.

FIG. 12 is an exemplary screen showing a portion of a CM table according to an embodiment of the present disclosure.

FIG. 13 is an exemplary method for creating an EM according to an embodiment of the present disclosure.

FIG. 14 is an exemplary screen showing a pre-defined EM class table according to an embodiment of the present disclosure.

FIG. 15 is an exemplary screen showing a portion of a definitions table for EM's according to an embodiment of the present disclosure.

FIG. 16 is an exemplary screen showing a portion of an acquire table for EM's according to an embodiment of the present disclosure.

FIG. 17 is an exemplary screen showing a portion of an interlock table for EM's according to an embodiment of the present disclosure.

FIG. 18 is an exemplary method for determining the availability of CM's for the operation of an example EM that delivers an ingredient according to an embodiment of the present disclosure.

FIG. 19 is an exemplary screen showing a faceplate in a process interlocks mode.

FIG. 20 is an exemplary screen showing the faceplate of FIG. 19 in a faults mode.

FIG. 21 is an exemplary screen showing a faceplate with a user selectable switch according to an embodiment of the present disclosure.

FIG. 22 is an exemplary screen showing the faceplate of FIG. 19 in a CM mode.

FIG. 23 is an exemplary screen showing the faceplate of FIG. 19 in a CM interlock mode.

FIG. 24 is an exemplary screen showing the faceplate of FIG. 19 in a detail setting mode.

FIG. 25 is an exemplary screen showing the faceplate of FIG. 19 in a permissives mode.

FIG. 26 is an exemplary screen showing the faceplate of FIG. 19 in a safety interlock mode.

FIG. 27 is a graphical display of a portion of a plant showing a unit.

FIG. 28 is an exemplary screen showing a faceplate for the unit of FIG. 27.

FIG. 29 is a diagrammatic view of a plurality of programmable logic controller (PLC's) showing the PLC's having distributed instructions and databases that communicate over a network.

Corresponding reference characters indicate corresponding parts throughout the several views. The exemplifications set out herein illustrate exemplary embodiments of the disclosure and such exemplifications are not to be construed as limiting the scope of the disclosure in any manner. The embodiments of the disclosure described herein are not intended to be exhaustive or to limit the disclosure to the precise forms disclosed. Rather, the embodiments selected for description have been chosen to enable one skilled in the art to practice the subject matter of the disclosure.

### DETAILED DESCRIPTION OF THE DRAWINGS

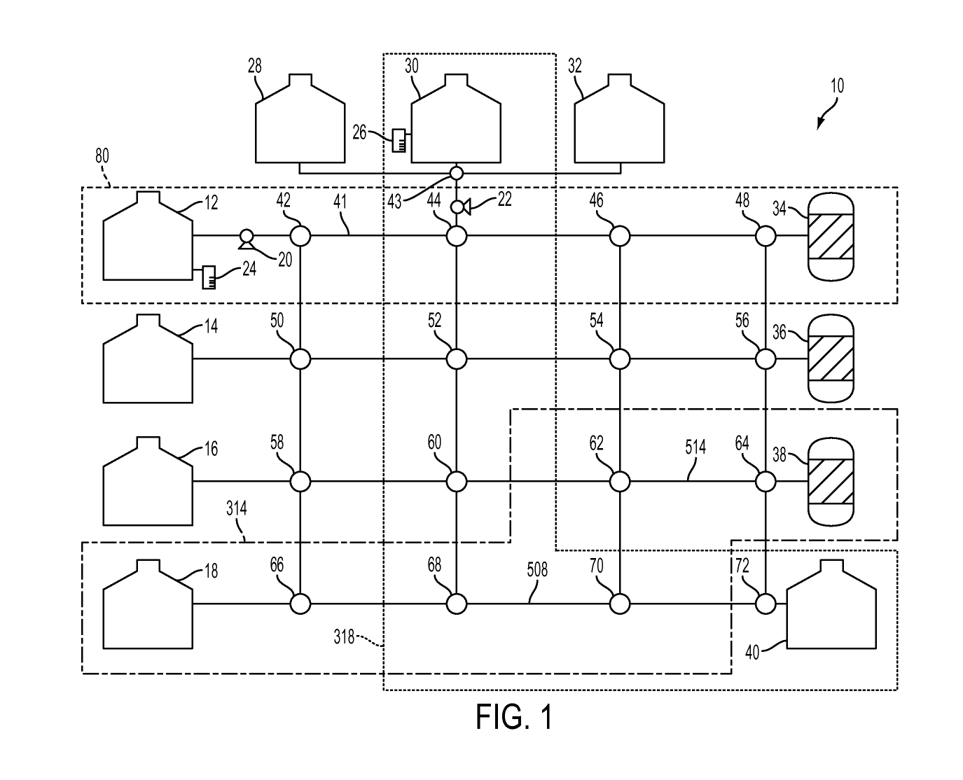

During manufacturing, various components or materials are often combined or assembled to create a finished product. For example in food manufacturing, various ingredients or materials are combined, mixed, and otherwise processed based on recipes at a food processing plant, such as plant 10 shown in FIG. 1. Programming software to operate the multitude of components (valves, pumps, agitators, etc.) plant 10 can be time consuming. According to the present disclosure, a database-based system is provided to operate the multitude of components. Although the systems of the present disclosure are described in the context of batch food manufacturing, they may also be used in the manufacture of other batch items, such as chemicals, pharmaceuticals, personal care products, or the discrete assembly of items or materials, such as electronics, automobiles, and other assembled items.

Plant 10 shown in FIG. 1 includes various components used in the production of final food products, such as ingredient tanks 12, 14, 16, 18; pumps 20, 22 (only two shown), measuring instruments 24, 26 (only two shown), cleaning tanks including water tank 28, caustic tank 30, and acid tank 32; action tanks such as cook kettles 34, 36, and 38; waste collection tank 40; pipes 41, and valves 42-72. During the creation of a processed food in exemplary plant 10, ingredients are moved from ingredient tanks 12, 14, 16, 18 to action tanks 34, 36, 38 under pressure created by pumps 20, 22. Valves 42-72 determine which ingredients flow to which action tanks 34, 36, 38 where the ingredients may be combined, mixed, cooked, or otherwise processed. Measuring instruments 24, 26, such weigh scales, flow meters, and other measuring instruments, measure how much of the ingredient is provided. Other instruments, measure other parameters of food processing, such as thermometers, pressure gauges, etc.

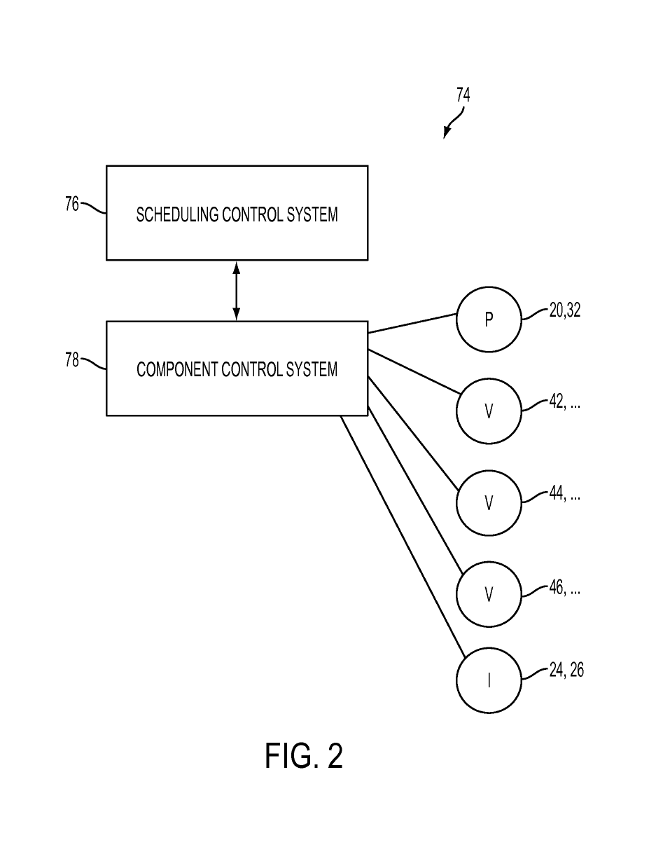

As shown in FIG. 2, food processing plant 10 includes a control system 74 that controls which ingredients and processes are performed within plant 10 to produce the desired food products. Many food processing plants create different food products in batches rather than through a continuous process of producing the same food product. For example, an ice cream plant may create a batch of vanilla ice cream, followed by a batch of chocolate ice cream, followed by a batch of strawberry ice cream, followed by another batch of vanilla ice cream, and so on, re-using ice cream recipes for each type of ice cream as required by a production schedule. Batch processing plants are typically more complicated than continuous process plants because of additional valves, pumps, etc. As a result, programming of a control system for a batch processing plant is also more complicated. Control system 74 is configured to simplify the control of complicated processing systems, even those that are not batch systems.

For illustrative purposes, control system 74 is divided into a scheduling control system 76, sometimes referred to as a manufacturing operation management system, and a component control system 78. Scheduling control system 76 controls when certain recipes are run in plant 10 and is programmed with recipes and other information. Component control system 78 controls the operations of the various components in plant 10 required to move and process the ingredients in accordance with recipe instructions received from scheduling control system 76.

As an example, it may be time to produce vanilla ice cream. Scheduling control system 76 knows the recipe for vanilla ice cream and instructs component control system 78 to deliver 500 pounds of cream from tank 12, which holds cream, to cook kettle 34. In response, component control system 78 instructs the necessary components between tank 12 and cook kettle 34 (ex. pump 20, valves 42, 44, 46, 48, and weigh scale 24) to deliver 500 pounds of cream as requested.

Scheduling control system 76 and component control system 78 work together to control the various components of plant 10 that operate to deliver, mix, and otherwise process the initial ingredients that result in the end food products. To facilitate operation of component control system 78, individual components of plant 10 are named and arranged in coordinated groups.

A control system engineer or other user may identify the components of plant 10 from the piping and instrumentation diagrams (“P&ID's”) created by a food process engineer during the designing of food processing plant 10. Certain source and destination points are often referred to as “units,” such as tanks 12, 14, 16, 18, 28, 30, 32 and cook kettles 34, 36, 38. Other components that control a discrete function, such as pumps 20, 24 and valves 42-72 are often referred as “control modules” (“CM's”). Normally, CM's do not control functions other than their own. Components that take measurements, such as flow meters, weigh scales, thermometers, are referred to as “instruments.” Collectively, these components contribute to the processing of the ingredients into the final food product.

During routing of ingredients and other processes, component control system 78 controls groupings of CM's (valves, pumps, agitators, etc) to perform the routing or processes. These groupings of CM's that together perform a process are often referred to as “equipment modules” (“EM's”). Some EM groupings include other EM's within their grouping.

Component control system 78 is configured to define multiple EM's used to carry out various functions within plant 10. For example, as described above, it may be necessary to deliver 500 pounds of cream from tank 12 to cook kettle 34. To perform this process, EM 80 (shown as EM 80 in phantom in FIG. 1) is activated. During configuration of component control system 78, EM 80 is named (ex. “Cream to Tank 34”) and each unit (ex. source and destination tanks), each CM (pump, valve, etc.), and instrument (ex. weigh scale, thermometer, push button) required for moving cream from tank 12 to cook kettle 34 is assigned to EM 80. In this particular example, EM 80 includes tank 12, cook kettle 34, pump 20, valves 42, 44, 46, 48, and scale 24. As such, these components are assigned to EM 80, named Cream to Tank 34. During creation of the ice cream, schedule control system 76 requests that 500 pounds of cream be sent to cook kettle 34. In response, component control system 78 calls up EM 80 and delivers cream from tank 12 to kettle 34 through valves 42, 44, 46, 48 under the power of pump 20 until weigh scale 24 detects that 500 pounds of cream have left tank 12. As discussed in greater detail below, additional components, such as valves 43, 50, 52, 54, 56 may be included in EM 80 to avoid misrouting of ingredients.

Because of the complexity of plant 10, programming all of the units, instruments, CM's, and EM's can be very time consuming. Component control system 78 is configured to reduce the programming time typically required for a complex plant (or portions/lines of a plant).

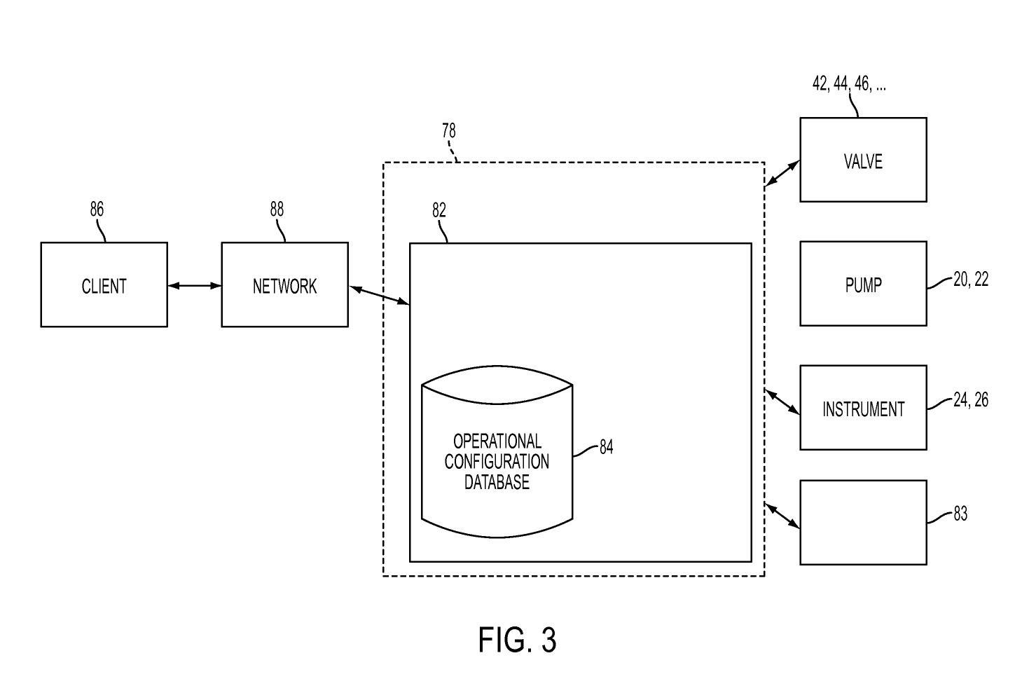

FIG. 3 shows a diagrammatic view of portions of component control system 78 including one or more programmable logic controllers (PLC's) 82 according to an embodiment of the present disclosure. PLC's 82 may include one or more systems that communicate with and/or control one or more instruments 24, 26, valves 42, 44, etc., pumps 20, 32, and other components 83 (agitators, burners, etc.) of plant 10. According to other embodiments of the present disclosure, PLC's 82 may be replaced by other automation controllers such as process automation controllers (PAC's), such as ControLogix PAC's provided by Rockwell Automation or emulated SoftLogix PAC's also provided by Rockwell Automation, as discussed below.

In the illustrated embodiment, PLC's 82 include connections to valves 42, 44, etc. Valves 42, 44, etc. in the illustrative embodiment, are electronically controlled valves that may be fully open, partially open, or closed, depending on the instructions provided by PLC's 82. Valves 42, 44, etc. may be operated independently, or may be operated as a single unit. PLC's 82 provides commands to valves 42, 44, etc. to open, partially open, or close depending on the commands presented by PLC's 82. Valves 42, 44, etc. may also send communications to PLC's 82 indicating, for example, the status of valves 42, 44, etc. or that PLC 82 command was executed, is in progress, or could not be executed. Valves 42, 44, etc. may also send additional information to PLC's 82 such as error status, or a message to indicate if valves 42, 44, etc. are currently in operation.

Component control system 78 further includes an operational configuration database 84 that is populated with data describing relationships, logic requirements, and physical and other information relating to the CM's, units, instruments, and EM's. The populating of configuration database 84 is described in greater detail below. During the initial population of database 84 or subsequent updating, control system engineer or other use uses a client computer 86 to communicate with PLC's 82 of component control system 78 via a network 88 or other connection. Client computer 86 is in communication with a user, and may present output to the user and receive input from the user. Client computer 86 may include, but is not limited to, a desktop computer, a laptop computer, a tablet computer, a smartphone, or another system. As discussed below in greater detail, operational configuration database 84 may be distributed across multiple PLC's 82 so that each PLC 82 has the data it needs to perform the tasks required of it.

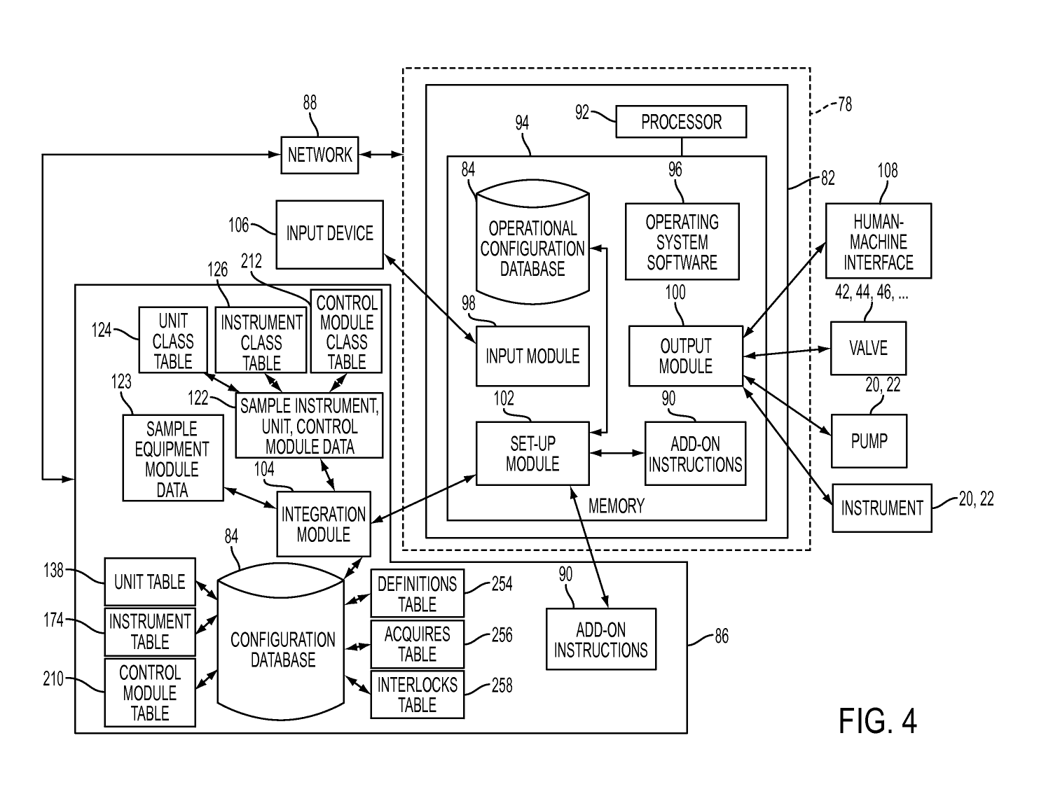

As shown in FIG. 4, component control system 78 includes generic pre-built instructions 90, which are downloaded to PLC's 82 through network 88 from client computer 86. PLC's 82 use instructions 90 to control the CM's (pumps, valves, etc.) and to receive input from the CM's and instruments (meters, etc.). Depending on the EM being used in a particular process, PLC's 82 pull data from operational configuration database 84 for use in instructions 90 to operate the CM's. As described in greater detail below, the use of operational configuration database 84 aids in the operation of component control system 78.

PLC's 82 of component control system 78 include one or more processors 92 and memory 94 containing operating system software 96, an input module 98, an output module 100, and a set-up module 102. The modules described herein may be in communication with other systems and/or databases that may operate either in the same physical computer system as component control system 78, or may operate on one or more separate physical computer systems. Although each module is described as operating within component control system 78, one or more modules may not be present, depending on the functionality desired of component control system 78. In one embodiment, component control system 78 is a single system. In another embodiment, component control system 78 includes two or more systems in communication with each other via one or more dedicated connections or network connections. Although processor 92, memory 94, database 84, etc. are shown in a single PLC 92, these features may be distributed or otherwise located across multiple PLC's 92 or in other locations, including locations outside of a PLC.

In the illustrative embodiment, input module 98 receives information from client computer 86, an input device 106, or a human-machine interface or “faceplate” 108 or other PLC's 82. In an embodiment, input module 98 receives data from these sources and rearranges or reprocesses the data so that it may be transmitted to other modules in component control system 78. Examples of input devices 106 include, but are not limited to: computer mice, trackpads, keyboards, touch screens, or one or more sensors.

In the illustrative embodiment, output module 100 transmits information received from one or more of modules 98, 102 to one or more output devices, such as valve 42, pump 20, EM faceplates 108, etc. Output module 100 may also communicate with network 88 or other networks 88, and may communicate with client computer 86 via the network 88. Other examples of output devices include, but are not limited to: other PLC's, television screens, computer monitors, and printers.

Set-up module 102 includes the software and other generic data structures to a PLC-based system. As described in greater detail below, set-up module also receives add-on firmware instructions 90 and configuration database 84 from client computer 86 after the initial creation and population of configuration database 84 in client computer 86.

As described more fully below, EM faceplates 108 and CM faceplates 360 allow a user access to modify or view the operation of component control system 78, configuration database 84, and/or the one or more PLC's 82 operating within component control system 78.

As mentioned above, configuration database 84 is populated based on P&ID's. The control system engineer may create a new configuration database 84 in response to a new P&ID, or a new installation of a component control system 78 at a factory or other site with PLC's 82 controlling CM's.

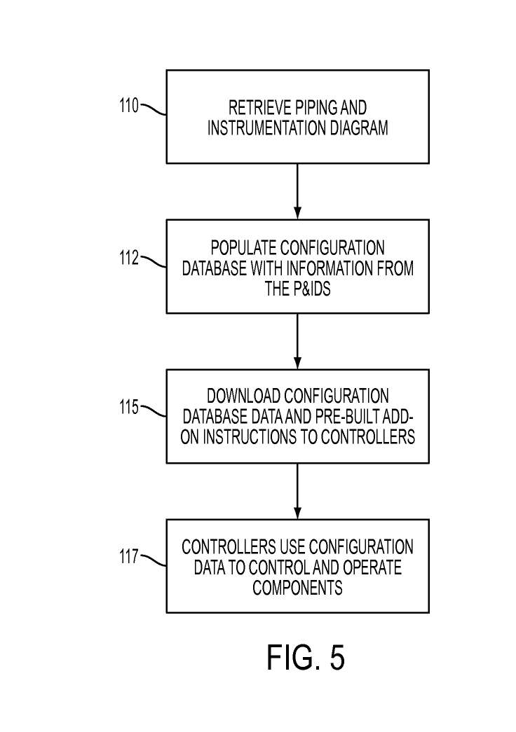

The initial population of database 84 typically occurs on client computer 86 which may be located within plant 10 or remotely from plant 10. As shown in FIG. 5, the first step in populating database 84 on computer 86 is to retrieve P&ID's at retrieval step 110. Based on the P&ID's, a control system engineer populates configuration database 84 with information relating to the physical components (valves, pumps, instruments, etc.) of plant 10 in step 112. Next, the control system engineer defines EM's in plant 10 by populating configuration database 84 with information pulled from the P&ID's that ties data entered in step 112 to the EM's. After database 84 is populated in client computer 86, it along with instructions 90 are transferred to PLC's 92 in download step 115. Finally in step 117, PLC controllers 92 use configuration database 84 and instructions 90 to operate plant 10 in response to request from scheduling control system 76.

During retrieval step 110 shown in FIG. 5, the control system engineer receives the P&ID's that are the basis for inputting information into configuration database 84 that is initially located in client 86. The P&ID's may be electronic, and may be imported into client computer 86 electronically. For example, the P&ID's may be created using a standard syntax or other format, and client 86 may import the P&ID's and populate configuration database 84 within client 86 using information from the P&ID's.

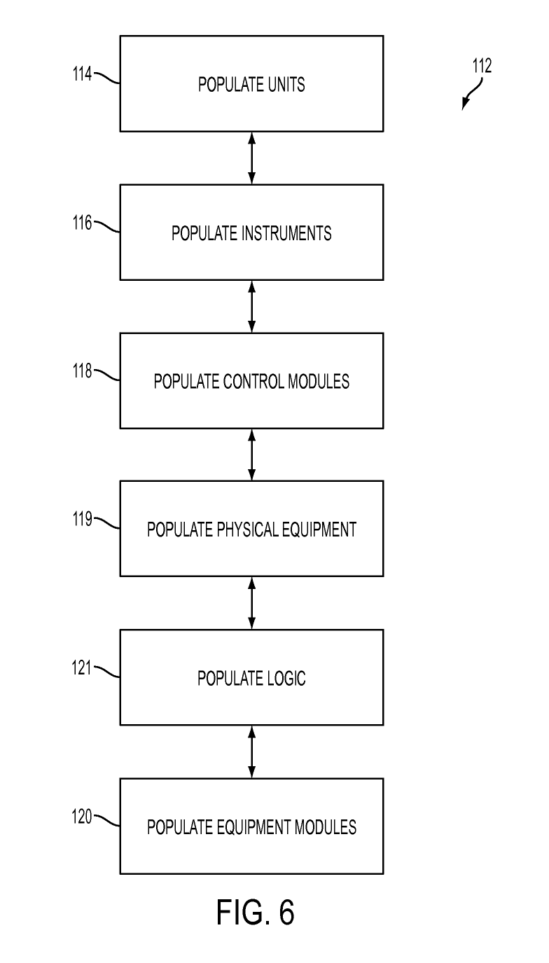

At populating step 112, the control system engineer populates configuration database 84 with data from the retrieved P&ID's and generic information that is common to many plants. As shown in FIGS. 5 and 6, information regarding various components of plant 10 is populated into configuration database 84 during populating step 112, which includes multiple steps. These include populating configuration database 84 with information relating to the units (ex. tanks 12, 34, etc.) at unit population step 114, information relating to instruments (ex. scales 24, 26) at instrument populating step 116, information relating to CM's (ex. valves 42, 44, etc., pumps 20, 32, etc.) at CM populating step 118, information relating to physical equipment such as pipes at physical equipment populating step 119, logic requirements at logic populating step 121, and information relating to EM's (ex EM 80) at EM populating step 120. As described in greater detail below, the sub-steps of populating step 112 may occur in any order and may occur simultaneously. For example, a control system engineer may start with populating database 84 with basic information regarding EM. Before populating other EM's, the control system engineer may populate database 84 with information regarding units/tanks 12, 34, instrument 24, valves 42, 44, 46, 48, and pump 20 before proceeding to the next EM. Similarly, the control system engineer may populate database 84 with data on a portion or all of the units, instruments, valves, pumps, etc. into database 84 before populating basic information about the first EM.

Much of the information for units, instruments, CM's and EM's may be generic to many plants. As such, a user may populate configuration database 84 using pre-built data from sample component database 122 and sample EM database 123, and may customize the pre-built data according to the specific requirements of the units, instruments, CM's, EM's of a specific plant, such as plant 10 as designed in the P&ID's.

For example, in the illustrative embodiment, PLC's 82 control valves 42-72. The control system engineer may search for or otherwise find a generic valve implementation in sample component database 122, and may configure an implementation for valve 42, using the specific features and requirements of valve 42. For example, and without limitation, valve 42 may be a valve that may only be fully open or fully closed. The configuration of a generic valve in sample component database 122 may include such a feature. In another embodiment, valve 42 may be a valve that may be opened fully, closed fully, or partially opened. The configuration of another generic valve in sample component database 122 may include this different feature. As explained more fully below, theses generic implementations of units, instruments, CM's (valves, etc.), and EM's are stored in sample database 122 and sample EM database 123, respectively.

An integration module 104 of client computer 86, receives the generic data from sample component database 122 and sample EM database 123, and allows the user to configure the units, instruments, CM's, and EM's according to the specific pieces of equipment for the project, such as plant 10 based on the P&ID's. The generic data and the configuration information is initially stored in configuration database 84 of client 86. Configuration database 84 is then converted to a format suitable for PLC's 82 and transmitted to PLC's 82, and instructions 90 use the information in the converted configuration database 84 in PLC's 82 to perform the tasks as directed by the EM's.

As mentioned above, many plants, such as plant 10, use common components. To facilitate populating steps 114, 116, 118, 120, sample data for such common components are pre-populated into configuration database 84 from sample component database 122. Sample component database 122 and the other databases discussed herein may be relational databases that include information regarding one or more generic items. In another embodiment, the databases use other structures to store the data. For example, the databases may include data stored in a hierarchical data structure, a flat file data structure, or another type of data structure that may allow the storage and recall of data.

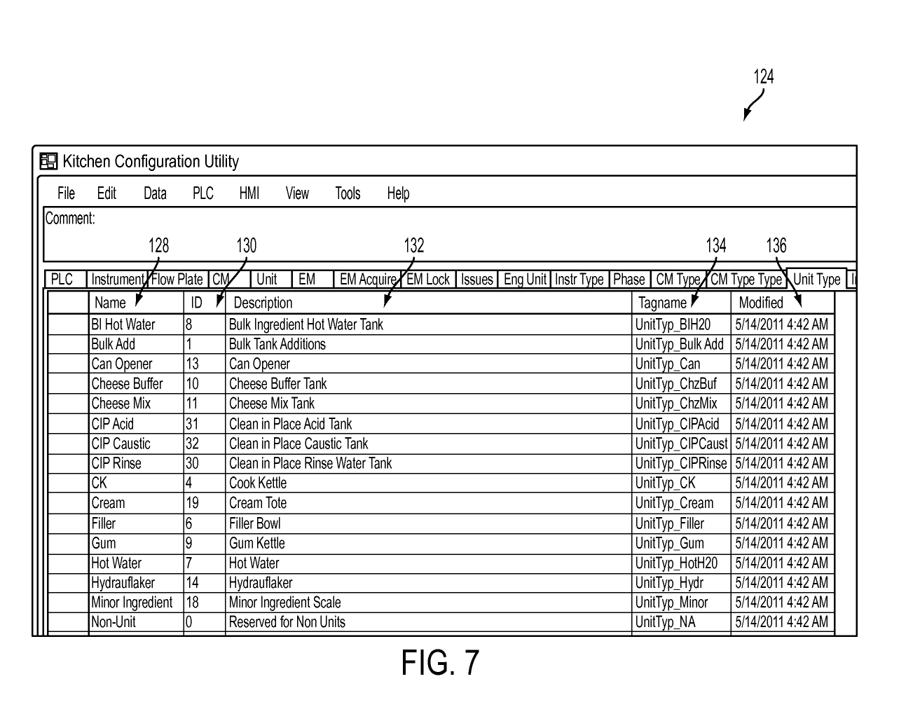

Sample database 122 includes a unit class table 124 and an instrument class table 126. As mentioned above, “units” may consists of source and destination points in a plant, such as tanks 12, 14, 16, 18, 28, 30, 32 and cook kettles 34, 36, 38. As shown in FIG. 7, unit class table 124 of sample database 122 includes a listing of common unit classes found in many plants. Within unit class table 124, common unit classes are provided with a name in column 128, an ID in column 130, a description in column 132, a tag name in column 134, and a date of last modification of the unit class in column 136.

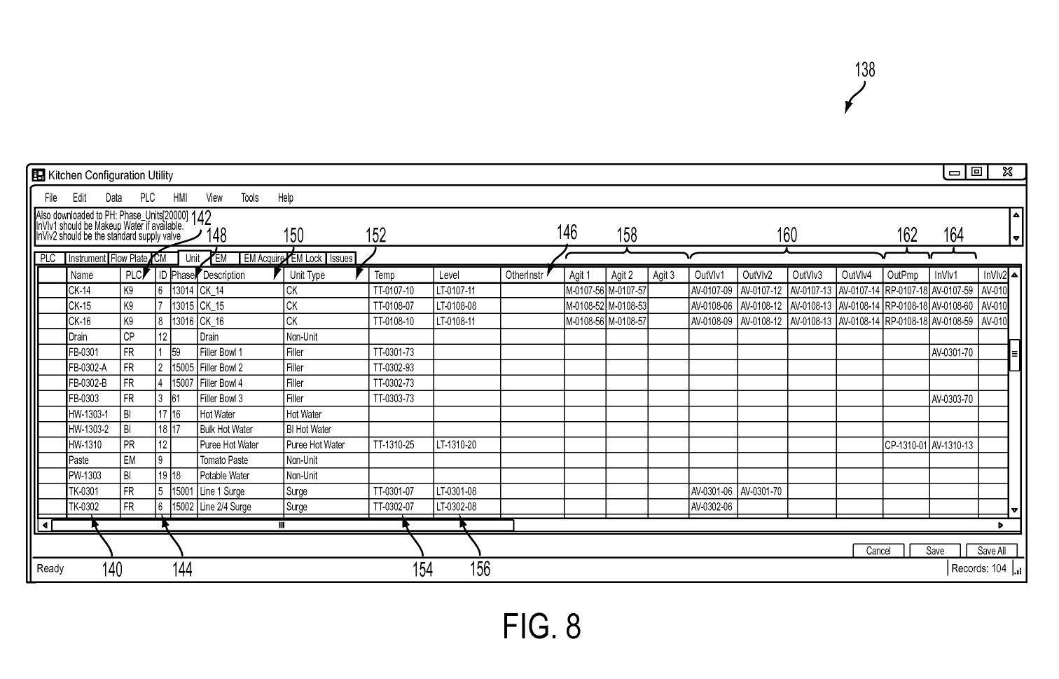

During population of configuration database 84 within client 86 during populate units step 114 of FIG. 6, the common unit classes of unit class table 124 are linked to a unit table 138 of configuration database 84. Unit table 138 includes a listing of all the units within plant 10 that are pulled from the P&ID's discussed above. As shown in FIG. 8, unit table 138 of configuration database 84 of client 86 includes a listing of the units within plant 10. Within unit table 138, each unit is provided with a name in column 140, an identification of the PLC 82 that controls the unit in column 142, an ID in column 144, a phase number in column 148, a description in column 150, a unit class in column 152 that is linked to the unit classes provided in unit class table 124, any temperature instrument associated with the unit in column 154, any level instrument associated with the unit in column 156, any other instruments associated with the unit in column 146, any agitators associated with the unit in columns 158, and outlet valves (ex. valves 42, 43, 50, 58, 66, etc.) associated with the unit in columns 160, any outlet pumps (ex. pumps 20, 32) associated with the unit in column 162, and any inlet valves (ex. valves 48, 56, 64, 72, etc.) associated with the unit in column 164, and any other information relating to the unit. Phase numbers 148 are used to match a request from scheduling control system 76 to the EM's stored in component control system 76. For example, EM 80 may have a phase number of “80.” To start EM 80, scheduling control system 76 sends phase number 80 to component control system 76, which recognizes 80 as the phase number for EM 80 and starts EM 80 in response. The instruments listed in columns 154, 156, 146 and the “control modules” (ex. agitators, pumps, valves, etc.) listed in columns 158-164 are linked from additional tables discussed below. Fewer or more columns of data may be provided for any of the tables discussed herein.

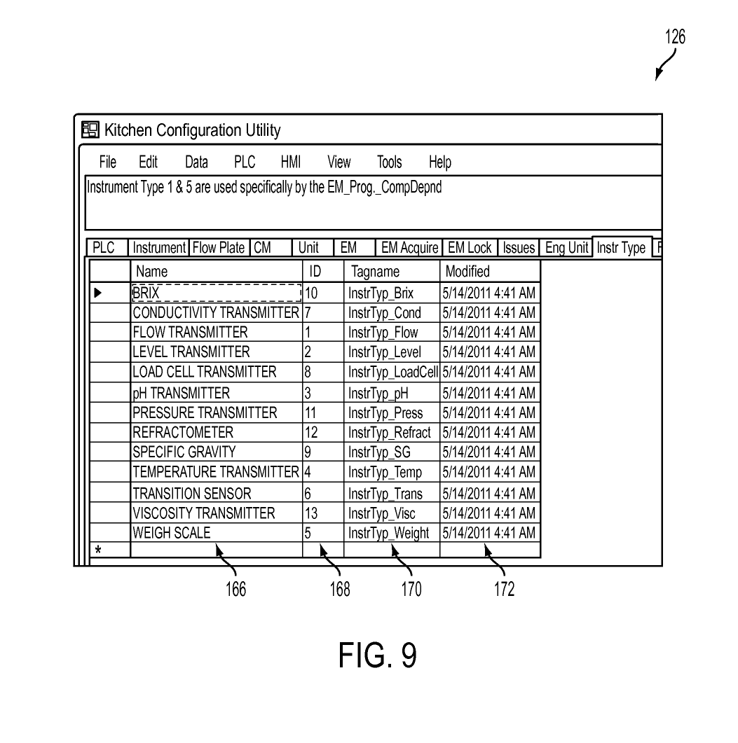

As mentioned above, “instruments” may consist of sensors and other measuring devices within plant 10 that provide feedback, such as scales 24, 26, flow meters, level meters, thermometers, push buttons, limit switches, and other sensors. As shown in FIG. 9, instrument class table 126 of sample database 122 includes a listing of common instrument classes found in many plants. Instrument table 126 may include generic or otherwise pre-defined instrument classes. Within instrument class table 126, each common instrument class is provided with a name in column 166, an ID in column 168, and a tag name in column 170, and a date of last modification of the instrument class in column 172.

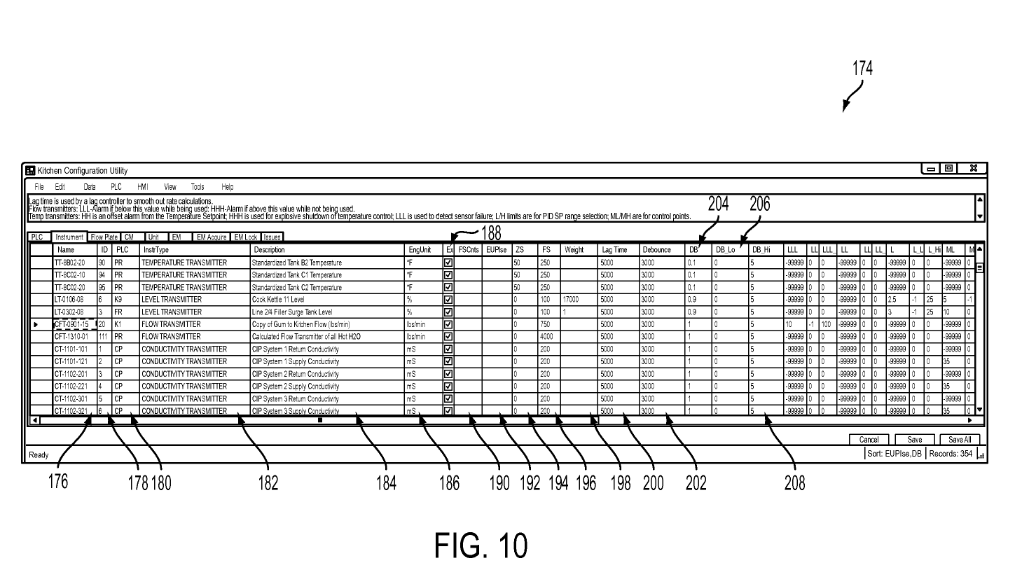

During population of configuration database 84 within client 86 in populate instrument step 116 of FIG. 6, the common instrument classes of instrument class table 126 are linked to an instrument table 174 of configuration database 84. Instrument table 174 includes a listing of all the instruments within plant 10 that are pulled from the P&ID's discussed above. As shown in FIG. 10, instrument table 174 of configuration database 84 of client 86 includes a listing of the instruments within plant 10. Within instrument table 174, each instrument is provided with a name in column 176, an ID in column 178, an identification of the PLC 82 that communicates with the instrument unit in column 180, an instrument class in column 182 that is linked to the instrument classes provided in instrument class table 126, a description in column 184, and the instrument's English unit of measure in column 186. The check box in column 188 is checked if the instrument actually physically exists. The instrument's additional parameters are, if applicable, are provided in columns 190-208 or in the other columns of instrument table 174. For example, each instrument may include alarm levels at which alarms are communicated. For example, a thermometer may have alarm levels at 2° C. and 98° C. to trigger alarms if there is a risk of water freezing or boiling. These alarm points could be stored in instrument table 174 and displayed in an HMI has discussed herein.

According to one embodiment of the present disclosure, a single physical instrument can be entered multiple times into instrument table 174 so that more instruments are entered into instrument table 174 than actually exists. Typically, this is done so that one physical instrument can perform as two different instruments. For example, as discussed above, alarm points may be provided for each instrument. If it is desirable for an instrument to have different alarm points for different EM's (ex. 2° C. and 98° C. for an EM using water and −6° C. and 104° C. for an EM using brine), the instrument can be entered into instrument table 174 twice: once with one set of alarm points and once with another set of alarm points. Each entry of the single physical would have many of the same values, such as instrument type, IP address, etc., but could have a different name (ex. “Thermometer 1: pure water and “Thermometer 1: brine)”.

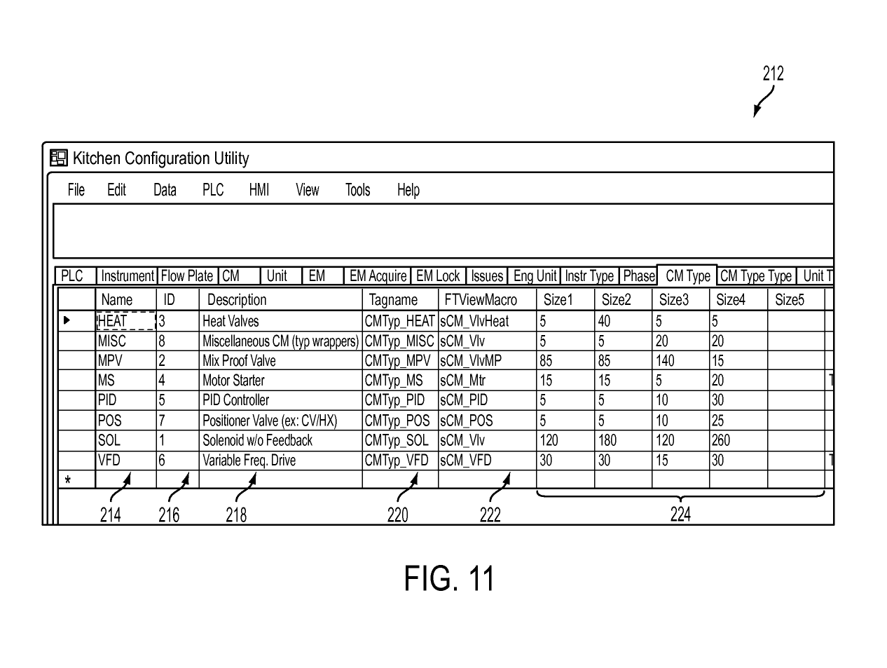

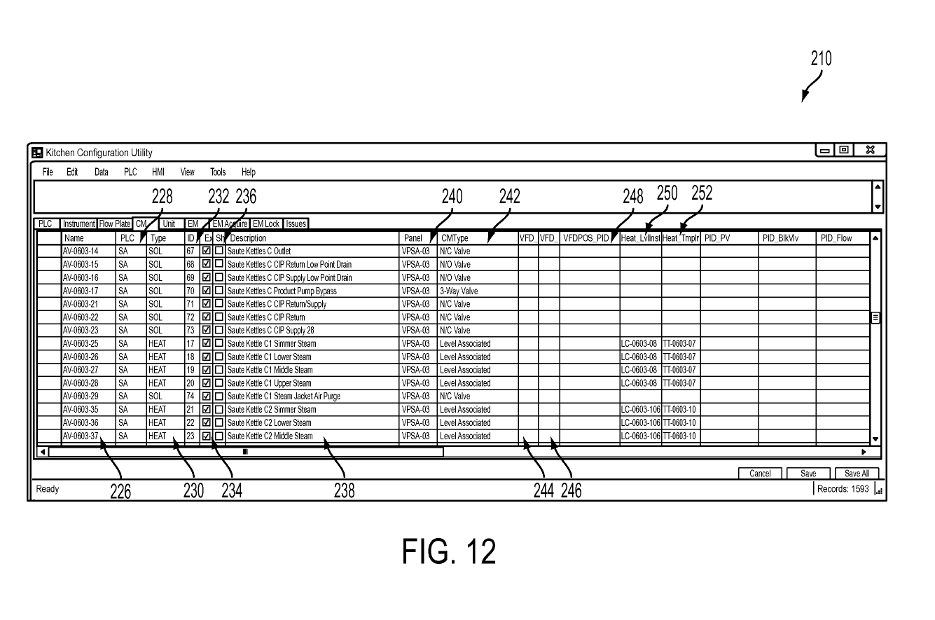

As mentioned above, “control modules” (“CM's”) may consist of plant components (ex. valves, agitators, pumps, etc.) that affect some action of the process or recipe in plant 10 such as controlling movement, stirring or agitating, heating, cooling, etc. As with the units and instruments, the control system engineer uses the information supplied by the P&ID to populate a CM table 210 shown in FIG. 12. Similar to units and instruments, common CM's may be pre-loaded into a CM class table 212 shown in FIG. 11. CM class table 212 of sample database 122 includes a listing of common CM classes found in many plants. CM class table 212 may include generic or otherwise pre-defined CM classes. Within CM class table 212, each common CM class is provided with a name in column 214, an ID in column 216, a description in column 218, a tag name in column 220, a macro is indentified in column 222 that dictates which faceplate type is pulled up for the particular for the particular class of CM, and a series of sizes for the components, if any, in columns 224. Other information, such as the date of last modification of the CM class may also be provided.

According to one embodiment of the present disclosure, manufacturers of CM's or other parties may provide instructions 90 for equipment that they or others manufacture or supply. Along with these instructions, they may provide proposed changes to configuration database 84 to support the provided CM class.

During population of configuration database 84 within client 86 during populates control modules step 118 of FIG. 6, the common CM classes of CM class table 212 are linked to CM table 210 of configuration database 84. CM table 210 includes a listing of all the CM's within plant 10 that are pulled from the P&ID's discussed above. As shown in FIG. 12, CM table 210 of configuration database 84 of client 86 includes a listing of the CM's within plant 10. Within CM table 210, each CM is provided with a name in column 226, an identification of the PLC 82 that communicates with the CM in column 228, a CM class in column 230 that is linked to the CM classes provided in CM class table 212, an ID in column 232, columns 234 is checked if the CM actually physically exists, column 236 is checked if the CM may be shared by multiple EM, a description in column 238, CM's′ location within plant 10 in column 240, a further identification of the CM class in column 242 that is independent of CM class table 212, and the other information about the CM′ may be provided in other respective columns 244, 246, 248, 250, 252.

As an example of a shared CM, valve 42 may be shared at the same time by two or more EM's when an ingredient from tank 12 is need at two destinations (ex. tanks 34, 36). If an instrument (not shown) is provided at each tank 34, 36 to determine how much of the ingredient has been delivered to each tank 34, 36, it is permissible for valve 42 to be acquired and open for simultaneous delivery to each tank 34, 36. However, if an instrument 24 is the only instrument available to determine how much of the ingredient has been delivered, valve 42 should not be indicated as shared. Otherwise, if valve 42 is open while attempting to deliver the ingredient to two destinations, it will be difficult to determine how much of the ingredient measured by instrument 24 when to which of the two destinations.

According to one embodiment of the present disclosure, the speed of response of some CM's may also be designated in CM table 210. For example, often, it is more efficient to operate CM's at their maximum practical speed to reduce the amount of time required for a task to complete or to increase the efficiency of a task. For example, it may be beneficial to immediately turn off a CM, such as a pump, when a desired result is achieved. By turning off the pump immediately, less energy is used by the pump. However, in some circumstances, rapidly turning off (or on) a CM may result in undesirable outcomes. For example if a CM in turned off immediately or rapidly, momentum in a fluid being transported may cause water hammer because the fluid “slams” against pipes, etc. To avoid water hammer, it may be desirable to slowly turn off the pump and/or slowly close the valves of a particular EM. According to the present disclosure, if a CM, such as a valve or pump, is entered into CM table 210 (or elsewhere), a check box (not shown) or other field may be provided asking if water hammer (or other adverse condition) is an issue. If so, the check box may be checked. As a result, the pump or other CM may turn off or close more slowly than a default setting that attempts to minimize the turn off time or the closing time. Additionally, if the box is checked, CM table 210 may prompt the user to enter a value indicating the amount of time (or other parameter) that controls the speed at which the pump slows down or a valve closes.

During the initial population of configuration database 84, water hammer (or other adverse condition) may not be an issue. However, after installation, such an issue may be detected. To solve the issue, a control system engineer can update operational configuration database 84 by modifying the data related to a CM that the engineer suspects will help solve the issue. For example, the check box discussed above for a pump may be checked and the other necessary operational parameters provided and operational configuration database updated. Because instructions 90 are not altered during the modification of operational configuration database 84, the effected production line of plant 10 need not be shut down while the water hammer issue is resolved by updating operational configuration database 84 with the new data regarding the pump. Furthermore, the initial effort to correct the problem may not be successful (i.e. slowing down shutdown of the selected pump didn't solve the water hammer or wasn't ideal). As a result, the engineer may continue to select other CM's (or modify the parameters for the initially selected pump) for modification until the water hammer issue is satisfactorily solved. With each iterative effort, the effected production line of plant 10 need not be shut down as operational configuration database 84 is updated.

As mentioned above, “equipment modules” (“EM's”) are combinations of CM's, instruments, units, and other EM's that perform various functions. During step 120 of FIG. 6, configuration database 84 is populated with data relating to the CM's, instruments, units, and EM's that define the various EM of a plant, such as plant 10. In addition to the tables discussed above, configuration database 84 includes a definitions table 254, an acquire table 256, and an interlocks table 258, and an EM class table 262, discussed in greater detail below, that together define the EM's.

In the present embodiment, the EM's are able to acquire and interlock all of the necessary CM's before operation. If a first EM is using a CM that a second EM needs for operation, component control system 76 will inform the user that the second EM cannot operate, and may further define the specific CM that is unavailable for to the second EM. To make these determinations, the necessary CM's are associated with each EM during configuration step 120.

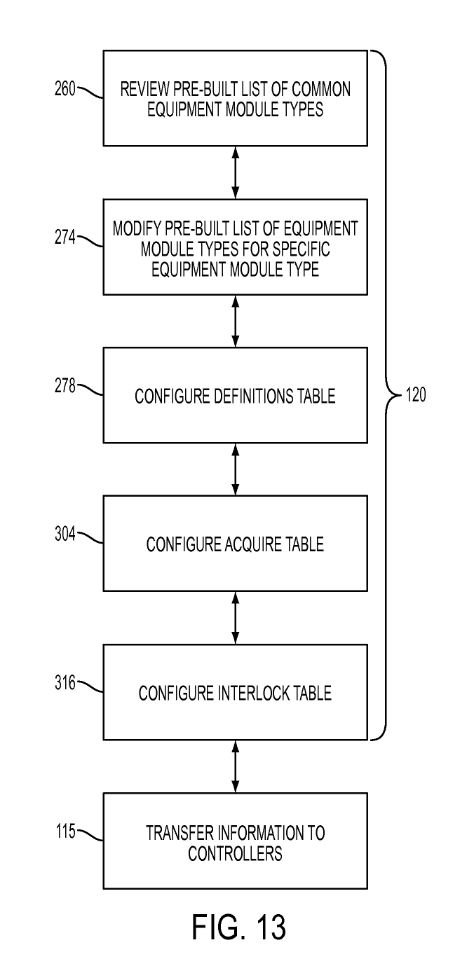

Sample EM database 123 includes information regarding one or more generic EM's that are used as a starting point for populating configuration database 84 with specific EM's. FIG. 13 shows exemplary sub-steps of step 120 of FIG. 6 for populating configuration database 84 with EM's according to an embodiment of the present disclosure.

Initially in step 260, a table of pre-built EM classes is provided in equipment class table 262 of sample EM database 123. EM table 262 includes generic EM classes that a control system engineer may customize by providing additional data to create specific EM's for a function of plant 10 in a manner similar to the units, instruments, and CM's discussed above.

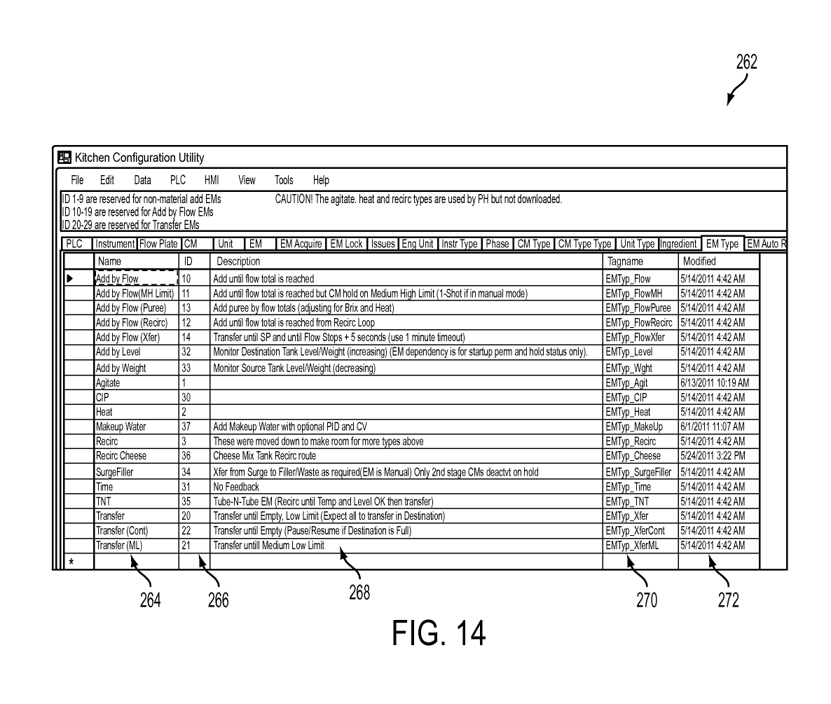

Sample EM class table 262 is shown in more detail in FIG. 14. As mentioned above, “equipment modules” or EM's may consists of collections of units, instruments, and control modules that perform a function or task. EM class table 262 of sample EM database 123 includes a listing of common EM classes found in many plants. Within EM class table 262, each common EM class is provided with a name in column 264, an ID in column 266, a description in column 268, a tag name in column 270, and a date of last modification of the EM class in column 272.

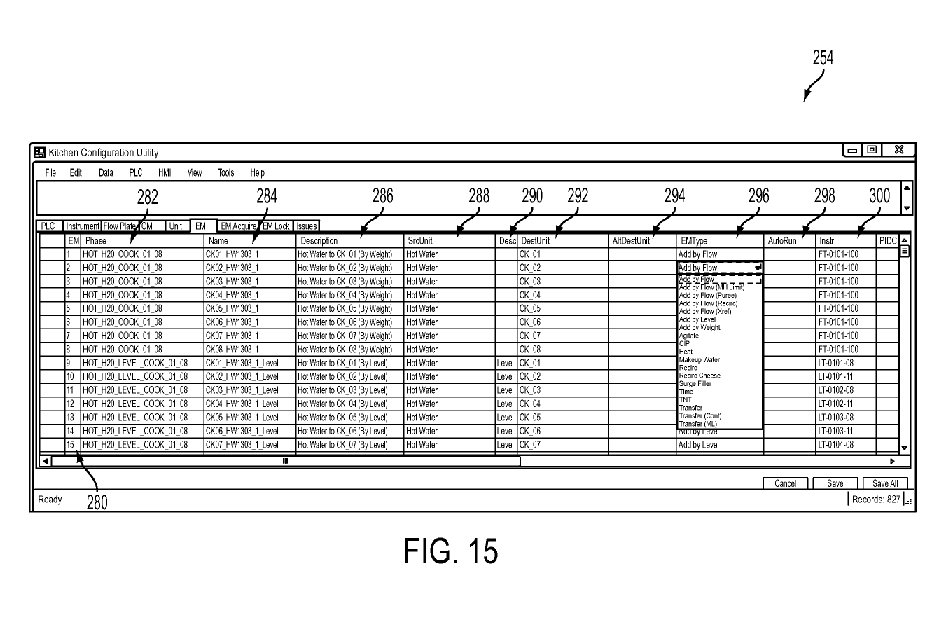

During population of unit table 138, instrument table 174, CM table 210, and EM definitions table 254, the control system engineer may notice that a given unit, instrument, CM, or EM class is not provided in the respective unit class table 124, instrument class table 126, CM class table 212, or EM class table 262. In response, the control system engineer populates the respective unit class table 124, instrument class table 126, CM class table 212, or EM class table 262 with a new unit, instrument, CM, or EM class. The control system engineer then links to the new unit, instrument, CM, or EM class by entering it into one of respective columns 152, 182, 230, 296. These columns 152, 182, 230, 296 may be populated by selecting from a pull-down menu (see FIG. 15) that lists the respective unit, instrument, CM, or EM classes listed in the respective unit, instrument, CM, and EM class tables 124, 126, 210, 262. Programming for pre-defined classes of units, instruments, CM, and EM are included in add-on firmware instructions 90 that are transmitted to PLC's 82.

If necessary in modification step 274 shown in FIG. 13, the control system engineer may modify sample EM class table 262 to suit the needs of the particular plant, such as plant 10, that is being programmed into configuration database 84. The control system engineer may also modify the other tables discussed herein to suit the needs of a particular plant. For example, the control system engineer may add custom programming to PLC's 82 to cause control of a new class of CM's, EM's, units, instruments, etc.

After any necessary modifications, the control system engineer populates EM definitions table 254 of configuration database 84 with data specific to each EM of plant 10 in EM population step 278. The definitions table includes information about the CM's that are included in the EM, and other information regarding the EM.

During population of EM definition table 254 of configuration database 84 within client 86 shown in FIG. 15, the common EM classes of EM class table 262 are linked to EM definitions table 254. EM definitions table 254 includes a listing of all the EM's within plant 10 that are used by scheduling control system 76 to manage the recipes as discussed above. As shown in column 282, EM definitions table 254 of configuration database 84 of client 86 includes a listing of the recipe steps or phases used within plant 10 to perform the recipes. Also within EM definitions table 254, each EM is provided with an ID in column 280, a name in column 284, a source unit in column 288 which is selected from a pull-down menu listing the units in column 150 of unit table 138, a description in column 286, an alternative source, if any, in column 290, a destination unit and alternative destination unit in respective columns 290, 292 from unit table 138, an EM class in column 296 from EM class table 262 as shown, and auto run column 298, any instruments used in the EM from instrument table 174, and any other information relating to the EM including any pumps, agitators or other CM's that are required by the EM. The information pulled from other tables are presented in pull-down menus that lists the units, control modules, instruments, etc. that are then currently listed in the respective tables. For example, only previously populated units from unit table 138 may be selected from a pull-down menu to populate column 292. As such, these cells are linked to other tables and avoids the need to manually enter data multiple times that may result in typographical and other data entry errors.

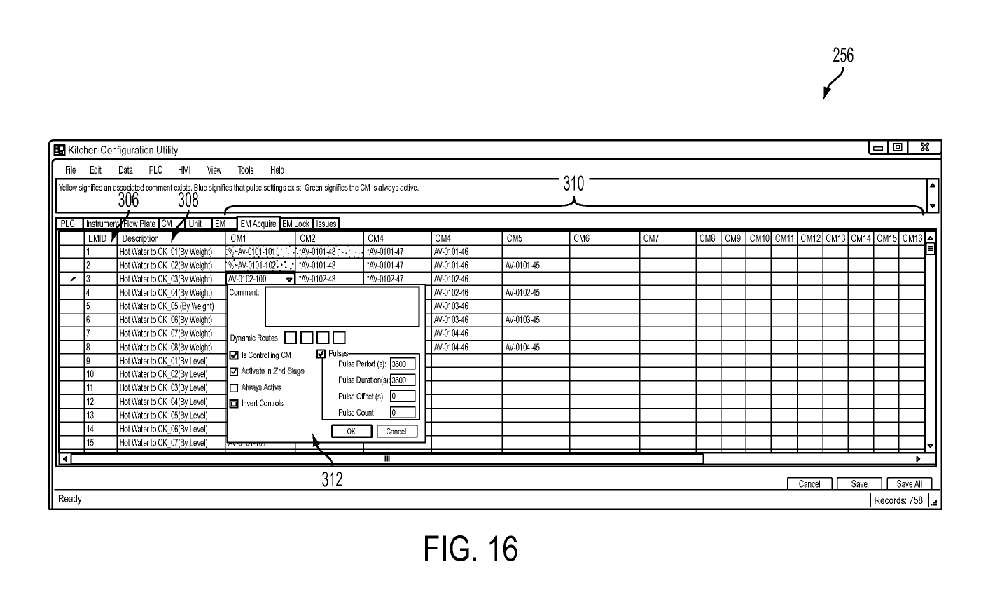

Referring again to FIG. 13, after the basic information of an EM is populated into definitions table 254 at step 278, the control system engineer proceeds to step 304 to populate or configure an acquire table 256 to lists all valves that need to be “acquired” and operated during the execution of the particular EM. When a PLC 82 acquires a valve, it has the ability to operate the valve and blocks other functions (ex. other EM's) from operating a valve. As shown in FIG. 16, acquire table includes columns 306, 308 listing the ID's and descriptions from columns 280, 286 of EM definitions table 254 shown in FIG. 15. Columns 306, 308 are automatically populated when columns 280, 286 are populated. Columns 310 list the valves for each EM that needs to be acquired during the execution of the respective EM. As shown in FIG. 16, one EM may have fewer or more valves that must be acquired compared to other EM's.

According to one embodiment, to populate columns 310, the control system engineer refers to the P&ID's to determine which valves need to be acquired. The control system engineer then selects a cell in columns 310 and a pull-down menu appears listing all valves populated into control module table 210 of FIG. 12. If a necessary valve is not listed, the control system engineer returns to table 210 and enters the missing valve. Upon return to table 256, the newly added valve is now listed and can be selected. According to the present disclosure, information for each selected valve can be displayed in fields 312. This information was populated in CM table 210 and may include the number of operations cycles required to rinse a valve during cleaning.

As an example of populating table 256, a control system engineer may first refer to a P&ID and determine that valves 66, 68, 70, 62, 64 of EM 314 shown in FIG. 1 need to be acquired. Assuming each of these valves 66, 68, 70, 62, 64 are already populated into CM module table 210, the control system engineer selects the cells in columns 310 and these valves 66, 68, 70, 62, 64 for inclusion into the row corresponding to EM 314 on table 256. Again, if a necessary valve is not populated into CM table 210, the control system engineer populates CM table 210 with the missing valve and returns to acquires table 256.

Interlock table 258 is used to identify all CM's that must be interlocked for each EM. For example as discussed above, a first-EM may require a specific set of CM's to be interlocked and acquired. If a second EM requires one or more of the same CM's to be acquired, the two EM's may not be able to be operated at the same time. If the second EM does not require any of the same CM's to be acquired as the first EM, then the two EM's may be operated simultaneously.

Referring again to FIG. 13, after acquire table 256 is populated, the control system engineer proceeds to step 316 to populate or configure an interlock table 258 to lists all valves that need to be locked out during the execution of the particular EM. When PLC's 82 lock out a valve, it blocks other functions (ex. other EM's) from operating the valve. Although a first EM may not need the interlocked valves to perform its function, the first EM needs to lockout the interlocked valves to prevent other EM's from interfering with the first EM's function.

For example as shown in FIG. 1, EM 314 only needs valves 66, 68, 70, 62, 64 to deliver ingredient from tank 18 to cook kettle 38. However, if EM 318 simultaneously attempts to clean pipes between caustic tank 30 and waste collection tank 40, EM 318 might attempt to open valves 44, 52, 60, 68, 70, and 72, which may result is caustic material passing through valves 68, 70 that are common to EM's 314, 318 and entering into cook kettle 38 and contaminating the food batch. Similarly, the ingredient being directed to cook kettle 38 by EM 314 may be drained to waste collection tank 40 because valve 72 would be open as a result of EM 318 attempting to operate. To avoid such contamination and misrouting of materials, EM 314 is programmed to lockout all valves that while not absolutely necessary to perform its function may have an adverse impact on its function. In the present example, EM 314 would interlock valves 58, 60, 54, 56, and 72 to avoid misrouting of materials into and out of the route of EM 314. According to the present disclosure, all CM's that may impact misrouting are populated into the EM's. According to alternative embodiments, EM's may or may not be populated with CM's to be interlocked.

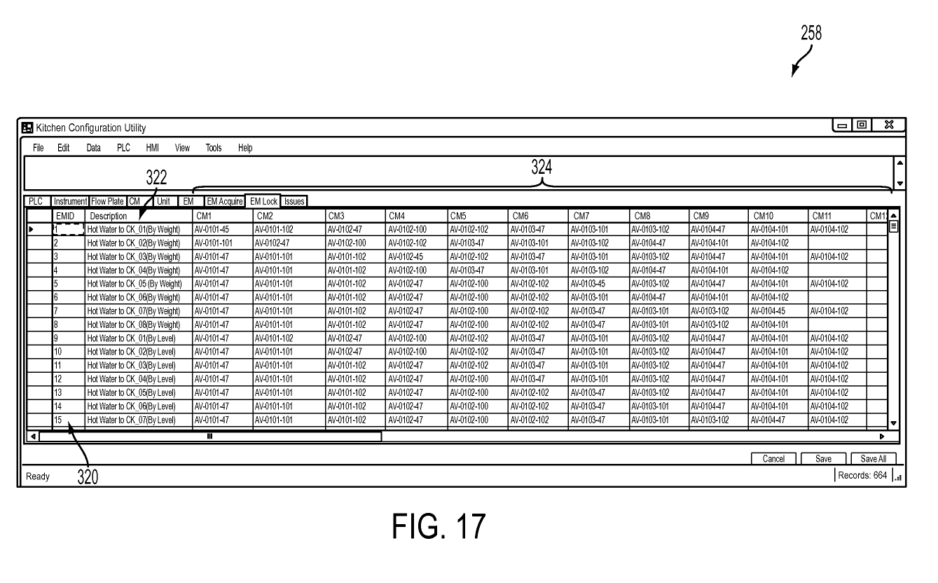

As shown in FIG. 17, interlock table 258 includes columns 320, 322 listing the ID's and descriptions from columns 280, 286 of EM definitions table 254 shown in FIG. 15. Columns 320, 322 are automatically populated when columns 280, 286 are populated. Columns 324 list the valves for each EM that need to be locked out during the execution of the respective EM so that other EM cannot activate the locked out valves. As shown in FIG. 17, one EM's may have fewer or more valves that must be interlocked compared to other EM's.

To populate columns 324, the control system engineer refers to the P&ID's to determine which valves need to be interlocked during operation of a particular EM. The control system engineer then selects a cell in columns 324 and a pull-down menu appears listing all valves populated into control module table 210 of FIG. 12. If a necessary valve is not listed, the control system engineer returns to table 210 and enters the missing valve. Upon return to table 258, the newly added valve is now listed and can be selected. As an example of populating table 258, a control system engineer may refer to a P&ID and determine that valves 58, 60, 54, 56, 72 of EM 314 shown in FIG. 1 need to be locked out. Assuming each of these valves 58, 60, 54, 56, 72 are already populated into CM module table 210, the control system engineer selects the cells in columns 324 and these valves 58, 60, 54, 56, 72 for inclusion into the row corresponding to EM 314 on table 258. Again, if a necessary valve is not populated into CM table 210, the control system engineer populates CM table 210 with the missing valve and returns to interlock table 258.

As also discussed below in relation to cleaning EM's, the timing of operation of various CM's of a given EM may be staged or timed relative to one another. For example, it may be desirable to have one CM start or stop a task before another CM starts or stops. As a further illustration in EM 80, it may be desirable for valves 42, 44, 46, 48 to open before pump 20 is activated. During population of one or more of the tables, staging or timing may be populated into configuration database 84. For example, a staging table related to an EM may include a several stages. Each stage may include one or more CM's that should start or stop at the same time. Each stage may also include a timing or trigger function that sets when the stage starts or stops. For example for EM 80, “Stage 1” may include valves 42, 44, 46, 48 that are triggered one second after the start up of EM 80. “Stage 2” may include pump 20 that is triggered two second after the start up of EM 80 or alternatively after valves 42, 44, 46, 48 all report a status of “open.” “Stage 3” may also include pump 20 that triggers stopping pump 20 when instrument 24 indicates that the amount of material delivered to kettle 34 is within a certain amount of the requested amount. “Stage” 4 may also include valves 42, 44, 46, 48 that are triggered to close a set number of seconds (ex. three seconds) after Stage 3. By staging the operation of CM's within a EM, greater control of CM's is possible within a given EM. For example, by opening valves 42, 44, 46, 48 at Stage 1 and turning on pump 20 later at Stage 2, pump 20 is able to pump against an open path to kettle 34 rather than a closed path.

As mentioned herein, EM's may include other EM's. By including one or more EM's in another EM, some EM's may be able to perform multiple tasks. For example, EM 80 may include an EM (“Recirculation EM”) that reroutes material back to tank 12 if kettle 34 is approaching full based on an indication from an instrument (not shown) associated with kettle 34. Facility 10 may include an additional pipe (not shown) that extends from valve 42 back to tank 12. The Recirculation EM would include this pipe and valve 42 that moves to a position directing the material to this pipe. The recirculation path provided by the Recirculation EM may be required, for example, if kettle 34 is approaching full and EM 80 needs stop or slow the delivery of material to kettle 34. Rather than stopping pump 20 to stop the flow of material (which can be inefficient and cause “water” hammering), EM 80 triggers the Recirculation EM to re-circulate material back to tank 12 and avoid overfilling kettle 34. After kettle 34 is allowed to drain sufficiently, EM 80 ends the Recirculation EM with valve 42 moving to a position directing material through pipe 41

EM 80 may also include an EM (“Alternative Path EM”) that includes opening valves 50, 58, 60, 62, and 54 and closing valve 44 that creates an alternative long path from valve 42 to valve 46. The Alternative Path EM may be required if a CM normally used by EM 80 is not available. For example, valve 44 may be under repair or in use by another EM. EM 80 may trigger the Alternative Path EM by receiving an indication at start up or otherwise that the status of valve 44 is “acquired” indicating that another EM is using valve 44 or a technician may have set the status of valve 44 during routine maintenance or otherwise. In yet another embodiment, EM's may be programmed to include multiple routes, each defined as an EM. For example, EM 80 may have a first EM that includes valves 42, 44, 46, 48 as described above and a second EM that includes valves 42, 50, 52, 54, 56, and 48. If one of valves 44 or 46 of the first EM are unavailable, EM 80 may switch to the second EM.

Some EM's may be used multiple times within an EM. For example, Alternative Path EM creates additional volume in the flow path of EM 80 from tank 12 to kettle 34. This additional volume may be required, for example, if kettle 34 is approaching full and EM 80 needs storage space to hold material from tank 12. If Recirculation EM is not available, rather than stopping pump 20 to stop the flow of material, EM 80 triggers the Alternative Path EM to “store” the material. While the pipes associated with the Long Path EM are filling up, kettle 34 is draining to provide sufficient space in kettle 34 to receive the material after the path of Alternative Path EM is filled. To facilitate the use of EM's (“child EM”) by other EM (“Parent EM), a Child EM table (not shown) is provided for each Parent EM that uses Child EM's. The Child EM table will include the identity of any child EM's used by the Parent EM and at least one triggering event that starts (or stops) the respective Child EM. For example, if EM 80 uses the Recirculation EM as discussed above, the Child EM table will include the ID of the Child EM (as provided in definition table 254) and the event that triggers the Child EM. For example, The Child EM table may include the ID of the Recirculation EM and a respective trigger when kettle 34 is 98%. Furthermore, the Recirculation EM may have another respective trigger, such as kettle 34 being 5% empty that turns it off. The Child EM table may include a field of pre-defined types of classes of triggering events (ex. time, instrument reading, CM status, etc.). These fields may allow a user to select the type of triggering event from a pull down menu. Based on the selection, other fields may allow the user to select a specific input device (ex. clock, instrument ID, CM ID, etc.) and a respective trigger value (ex. 5 seconds, 95% full, “acquired”, etc.). EM table 254 may include a check box for each EM indicating whether the EM is a Parent EM with associated Child EM's. If selected, the instructions transmitted to the PLC's, monitor the triggering events to determine if any of the trigger values occur. If a triggering event does occur, the instructions start (or stop) the respective Child EM.

According to one embodiment of the present disclosure, some CM's may including multiple CM's, but act as a single CM (“Coordinator CM”) within an EM. Such a Coordinator CM is defined within a table (not shown) that lists the name of the “Coordinator CM” and the CM's that are included in the Coordinator CM. Rather than listing the multiple CM's in the appropriate EM table, the Coordinator CM that includes those CM's can be listed in the respective EM table. If the Coordinator CM is used in multiple EM's, it can be listed in each respective EM rather than listing the multiple CM's in each EM.

After all tables are populated, configuration database 84 in client 86 is converted and transmitted to PLC's 82 along with instructions 90 in transfer step 115 shown in FIGS. 5 and 13. Instructions 90 use the information in configuration database 84 to perform functions within plant 10 as shown at step 117 of in FIG. 5.

During step 117, component control system 78, shown in FIG. 2, is ready to receive requests from schedule control system 76 during performance of recipes. Instructions 90 provided in PLC's 82 include logic in the form of one or more computer programs that use the data in the configuration database 84 to control and receive feedback from CM and instruments necessary during the operation of any given EM. Instructions 90 also include additional logic to transmit status information to component control system 78 and/or EM and CM faceplates 108, 360, and to receive information from client 86, faceplates 108, 360, or any other input to change data in configuration database 84 and/or other information in PLC's 82.

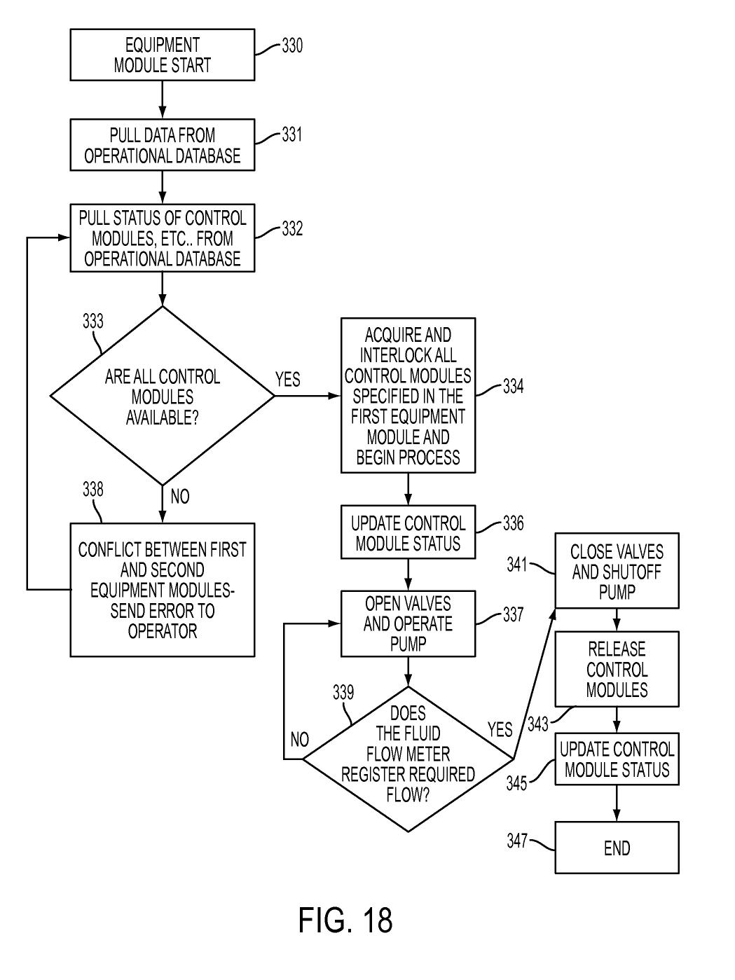

FIG. 18 illustrates one instruction for the delivery of an ingredient to a tank. During normal operation, instructions 90 are not modified, but rather reference the information in configuration database 84 to run the requested EM (ex. move brine from tank 18 to cook kettle 38 in the case of EM 314). PLC's 82 use the same instruction 90 for similar EM's, but pull different data for each specific EM from configuration database 84. For example, PLC's 82 will use the same instruction for EM 80 shown in FIG. 1 as EM 314 because both EM 80 and EM 314 have the same basic function of delivering an ingredient from a tank (ex tanks 12, 18) to a cook kettle (ex. 34, 38). However, PLC's will pull different data from configuration database 84 for each EM 80, 314, resulting in different control modules (ex. valves) and instruments being used during the similar function.

During operation of plant 10, scheduling control system 76 may request that two EM's operate simultaneously. To avoid conflicts between EM's, component control system 78 determines which programmed CM's of the EM have been acquired or interlocked by another EM before activating the requested EM. FIG. 18 is an exemplary instruction 90 or method for determining the availability of CM's for the operation of an EM according to an embodiment of the present disclosure.

In start step 330, scheduling control system 76 requests that an EM start. This request may be initiated by as part of a multi-step recipe or other process of two or more EM's, or may begin as prompted by the user.

After staring, PLC's 82 pull the necessary information for the present EM from operational database 84 stored in PLC's 82 in data retrieval step 331. In the example of EM 314 supplying 50 gallons of brine, PLC's 82 pull information from database 84 including the source unit (tank 18), the destination unit (cook kettle 38), the CM's to acquire (valves 66, 68, 70, 62, 64), the CM's to interlock (valves 58, 60, 54, 56, 72), any instruments providing feedback (ex. a flow meter, not shown), and any pump (not shown) to power movement of the brine.

Next, PLC's 82 check to determine if another EM is currently using any of the required CM's (valves, pumps, etc.) or any of the required CM's are otherwise unavailable at inquiry step 332. As mentioned above during operation, CM's communicate their status to PLC's 82. PLC's 82 save the status of each CM in operational database 84. After inquiry step 332, PLC's 82 make an inquiry to operational database 84 for the status of each required CM of the requested EM at step 332. For example for EM 314, PLC's 82 would request the status of valves 66, 68, 70, 62, 64, 48, 60, 54, 56, 72, any instruments of EM 314, and any pumps of EM 314. In step 333, PLC's determine if all the required components are available. If so, PLC's 82 proceeds to step 334 to acquire and interlock the CM's and other components associated with the requested EM (ex. EM 314) based on acquire and interlock tables 256, 258 as discussed above. After acquiring and interlocking the associated CM's in step 334, the status of the CM's and other components are updated in database 84 in status update step 336 and PLC's 82 continue the requested instruction 90 at step 337 by opening the required valves (ex. valves 66, 68, 70, 62, 64) and operating the pump designated by configuration database 84. While the valves are open and the pump is running, the instrument designated by configuration database 84 monitors the flow of brine until it reaches the quantity requested by scheduling control system 76 in flow monitoring step 339. Once the requested amount of brine is delivered, instructions 90 proceed to close the valves and turn off the pump at shut down step 341. The acquired and interlocked CM and other components are released (i.e. un-acquired) and unlocked at release step 343 and the released and unlocked CM's update their status in status step 345 and the EM ends at end step 347.

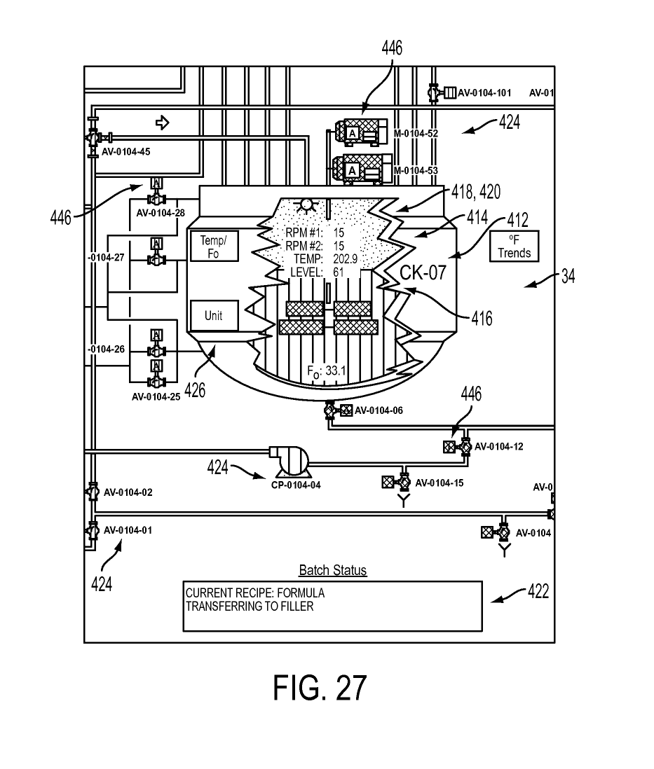

If in inquiry step 333, a CM or other component was unavailable because it was acquired or interlocked by another EM or otherwise unavailable, PLC's 82 proceed to conflict step 338. In conflict step 338, if one or more of the CM's is acquired or locked by another EM or otherwise unavailable, the requested EM cannot operate in its current state. Instructions 90 raise an alert to the scheduling control system and/or operator and delay the implementation of the requested EM. The error alert may be displayed on the background of HMI 108 shown in FIG. 27 in the form of a message 422 or by flashing the unit button FIG. 27 or by flashing an EM tile 442 or by flashing a CM tile 354 or CM tile as shown in display area 388 or by other alert displayed on one or more of faceplates 108, 360. The user may be able to view the CM or modules that are acquired and required by the EM, or may use another faceplate to define a different set of CM's that may be used to accomplish the same task as those defined in the EM. Once the CM being the root cause of the alert is determined, the user may actuate Acquired By button 382 to display EM pop-up 108 for the EM which has acquired or interlocked the problem CM. With both of EM faceplate 108 representing the REQUIRING EM and the EM faceplate 108 for the ACQUIRING EM open, the user can determine an appropriate action and take any such action, or not take any action, as is most desirable. In another embodiment, component control system 78 and/or the PLC 82 may suggest an alternate collection of CM's that may be used to accomplish the same task for the EM.

As an example, if EM 318 of FIG. 1 was in use when EM 314 was requested, PLC's 82 would check the status of all the CM's of EM 314 and determine that common valves 60, 68, 70 were already acquired by EM 318 and common valves 66, 62, 64 were interlocked by EM 318. As such, PLC's 82 would recognize a conflict between EM 314 and EM 318 and send an error message to the scheduling control system and/or an operator or hold up the implementation of EM 314 until EM 318 was finished and valves 60, 68, 70, 66, 62, 64 were no longer used by another EM, such as EM 318.

In the above example, valves 54, 58 are already interlocked by EM 318 and EM 314 would also need to interlock valves 54, 58. If the only conflict between EM 318 and EM 314 were common interlock valves, PLC's 82 would allow EM 314 to proceed because the conflict is not an issue. As discussed below in greater detail, PLC's may also suggest alternative routes to the operator to avoid the conflict.

Because instructions 90 are re-used for similar functions (ex. EM's 80, 314 provide the same function, but use different data from database 84), it is not necessary to copy or hard-code instructions for each specific EM or CM. Because it is the information pulled from operational configuration database 84 that changes during each re-use, instructions 90 do not require further modification even if the information in operational configuration database 84 is changed after the initial set-up. For example, if valve 44 needs repaired and EM 80 needs re-routed during the repair, operational configuration database 84 can be updated by modifying acquire table 256 and interlock table 258. During the update, valve 44 may be replaced in acquire table 256 with valves 50, 52, 54 and valves 50, 52, 54 are replaced in interlock table 258 by valves 44, 58, 60, 62. During this update, instructions 90 do not need modified. Furthermore, because instructions do not need modified, plant 10 can continue to operate.

In addition to re-routing EM's while plant 10 remains operational, equipment and related CM's and EM may be changed by replacing it with new or updated hardware, software, and/or data. A control system engineer updates operational configuration database 84 accordingly and transmits the changes in operational configuration database 84 in PLC controllers 82. Once again, instructions 90 stored in memory 94 of controllers 82 use the updated configuration information in updated operational configuration database 84 to instruct PLC controllers 82 without the need for instructions 90 to be reprogrammed and/or downloaded to controller 82 again.

According to one embodiment of the present disclosure, some EM's start without being prompted by scheduling control system 76. For example, some EM's may start (or stop) based on instrument outputs. In one example, an EM includes a CM, such as an light bulb, that lights anytime another CM, such as an agitator, is activated. Further, another EM might include an agitator and a level sensor. Anytime the level sensor detects a level in a kettle (or tank) reaches are certain height, the EM turns on the agitator. When the level sensor detects that level is below a certain height, the EM turns off the agitator. Each of these examples did not require prompting from scheduling control system 76.

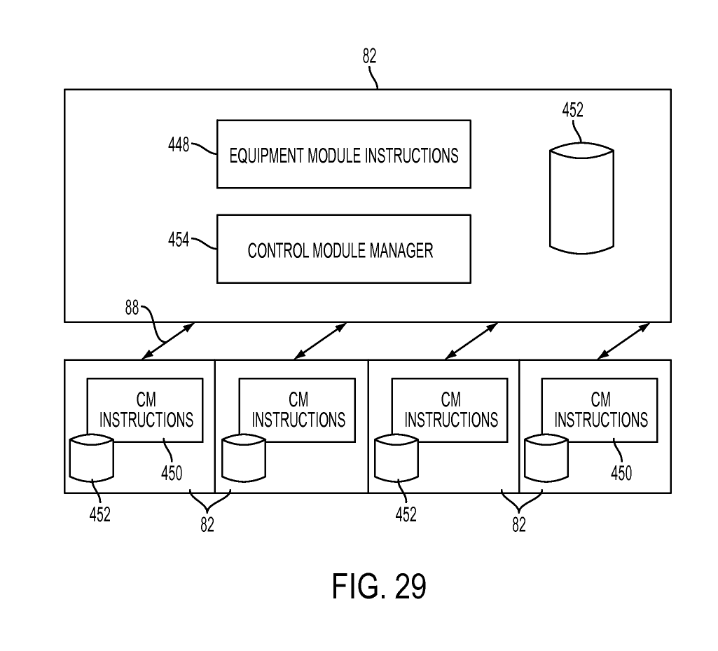

As mentioned above, component control system 78 can include multiple PLC's 82. Operational database 84 and instructions 90 may be stored in the memory of a single PLC 82 that communicates directly with instruments, CM's, and HMI's or the single PLC 82 may communication with the instruments, CM's, and HMI's through other PLC's 82 of component control system 78, Further, operational database 84 may be stored in the memory of one PLC 82 or distributed among multiple PLC's 82. Similarly, instructions 90 may be stored in the memory of one PLC 82 or distributed among multiple PLC's 82. As shown in FIG. 29, control system 78 includes multiple PLC's 82. Instructions 90 are distributed among these PLC's 82 and include EM instructions 448 and CM instructions 450. Similarly, database 84 is distributed among the PLC's 82 and includes databases 452. PLC's 82 communicate over network 88. By distributing instructions and/or database 84 over multiple PLC's 82, less information needs to be communicated over network 88, which avoids network-related communication delays.

In one example, instructions and data directly impacting CM's, such as CM instructions 450 and data stored in one of databases 452, are stored in the memory of PLC's 82 that receive input and send outputs directly to these respective CM's. For example, EM 80 may receive instructions to deliver 40 pounds of brine to kettle 34. The operation of pump 20 is controlled by the output of instrument 24. Similarly, the closing of valves 42, 44, 46, and 48 may be controlled by the status of pump 20. CM instructions 450 may include instructions that monitor the output of instrument 24 to determine when to turn off pump. Similarly, a database 452 stored in that PLC maintains the status of pump 20 (on or off) and the amount of time after pump 20 turns off (ex. two seconds) that valves 42, 44, 46, and 48 should be closed to avoid water hammer.

EM instructions 448 send data over network 88 regarding which CM instructions 450 should be run and the amount of material. Upon receipt, CM instructions 450 pull data from the respective database 452 sufficient to run its portion of the EM task and runs the appropriate instructions. For example, EM instructions 448 may communicate the identity of a specific CM instruction 450 and the amount of brine to deliver. Upon receipt of the amount, the indentified CM instructions 450 pull the necessary data from database 452 without the need to communicate over network 88 because the respective database 452 resides in the same PLC 82. Based on this data, CM instructions 450 knows the identity of instrument 24, pump 20, and valves 42, 44, 46, and 48 that are required to complete this portion of EM 80's task. Additionally, CM instructions 450 pulls any staging or triggering event information from database 452, such as when to close valves 42, 44, 46, and 48 after the status of pump 20 changes from on to off.

At Stage 1, CM instructions 450 requests the weight of material in tank 12 from instrument 24 based on the instrument ID provided by database 452. In Stage 2, CM instructions 450 valves 42, 44, 46, and 48 to open. In Stage 3 and based on the status of valves 42, 44, 46, and 48 from database 452, CM instructions 450 turn on pump 20. CM instructions 450 monitor the input from instrument 24 until the initial weight drops by 40 pounds before moving to the next stage. Next in Stage 4, CM instructions 450 turn pump 20 off, Next in Stage 5, CM instructions 450 monitor the status of pump 20 stored in database 452 until it changes to “off” and then closes valves 42, 44, 46 and 48 after two seconds as indicated by the timing data pulled from database 452. Upon completion of this task, CM instructions 450 send an indication to EM instructions 448 through network 88. For example, CM instructions 450 may send an indication that pump 20 is off and the task is complete. According to another embodiment, CM instructions 450 may send an indication to EM instructions 80 that instrument 24 has detected that 40 pounds of material has been removed from tank 12 without waiting for the status of pump 20 changing to off.

To facilitate communications between EM instructions 448 and CM instructions 450, the respective PLC 82 that stores EM instructions 448 includes a CM manager 454 as shown in FIG. 29. CM manager 454 knows which PLC's 82 are storing CM instructions 450 for each respective CM. When EM instructions 448 send instructions, CM manager 454 pulls from its respective database 252 the ID of the specific PLC 82 that contains the CM instructions 450 for a respective CM. CM manager 454 then sends the instructions from EM instructions 448 to the identified PLC 82.

During operation of plant 10, plant operators may interact with PLC's 82 using faceplates 108, 360 and may override instructions 90 or receive information on the status of an EM via EM faceplates 108. Faceplates 108, 360 may be a screen or other user interface that shows the status of one or more EM's and/or CM's.

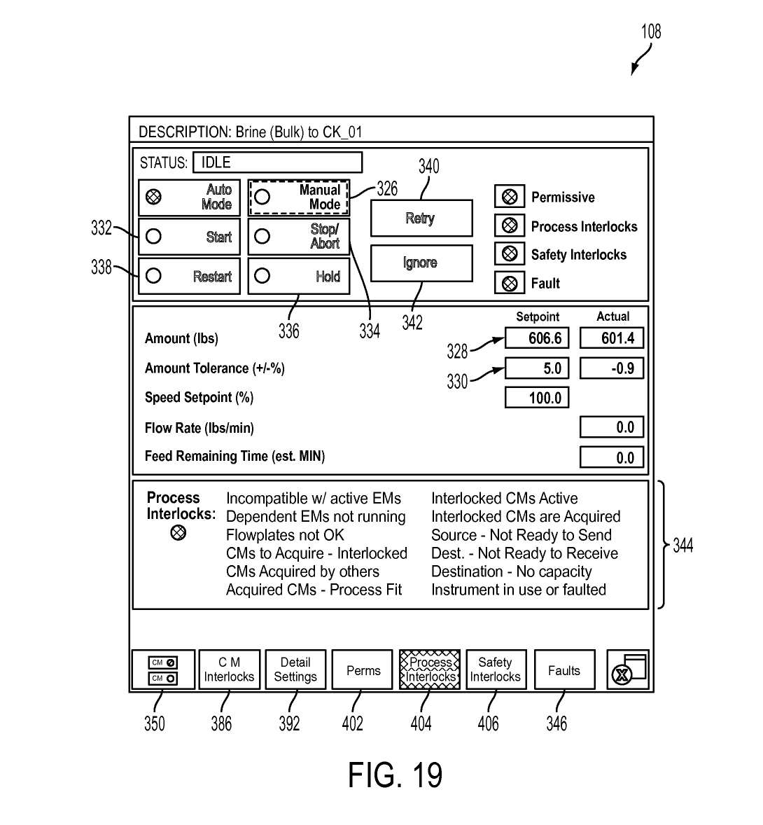

FIG. 19 is an exemplary screen showing an EM faceplate 108. According to the present embodiment, EM faceplate 108 is a template that pulls information from operational configuration database 84 and other sources, such as scheduling control system 76, instruments, CM's, etc. EM faceplate 108 of FIG. 19, provides information on the status of the EM, such as how much of the ingredient (ex. 606.6 lbs. of brine) scheduling control system 76 requested be moved to the destination (ex. cook kettle 1); how much of the ingredient has been moved (ex. 601.4 lbs of brine), the tolerance for the amount of the ingredient to be moved (ex. 5%), and the actual deviance between the actual and requested amount (ex. −0.9%). During operation of the EM running in FIG. 19, flow rates and estimates of remaining time are also provided.

Using EM faceplate 108, the operator may switch to a manual mode by selecting manual mode button 326. When in the manual mode, the operator may stop, start, re-start, and hold processes being performed by the EM (ex. moving brine for a bulk brine tank to cook kettle 1). When in manual mode, an operator may manually enter the amount of the ingredient to be delivered in setpoint field 328 and a tolerance in tolerance field 330. After entering the amount and tolerance, the operator starts the EM by pressing start button 332. The process can be stopped completely by pressing stop button 334 or paused by pressing hold button 336. While being held, PLC's 82 may turn off any associated pumps. To restart a held EM, the operator presses restart button 338. When restarted, the amount of material delivered will continue from the amount delivered before hold button 336 was pressed. When stopped, the amount of material delivered will restart from zero.

During the operation of EM's, it is possible that an EM will stop before all the requested ingredients are delivered. For example, some EM's have set maximum run times in which they will stop delivering ingredients after the set amount of time has passed. For example, if scheduling control system 76 requested 1588 lbs of brine, but the source tank contained only 1400 lbs of brine, the EM will attempt to deliver brine until its maximum run time is reached. At such a time, PLC's 82 will send an error message to an operator indicating that an error has occurred. PLC's 82 may notify the operator of the specific error (ex. “Brine Tank 18 is empty”) or the operator may need to determine the source of the error on their own.

Once an operator solves the error (ex. requests that brine tank 18 be filled), the operator may press retry button 340 for PLC's 82 to retry delivering the remainder of the brine. If the amount of brine delivered at the time of the delivery is acceptable or the operator otherwise rectifies the issue (ex. the operator used another EM faceplate 108 to manually deliver brine from another brine tank), the operator can press ignore button 342 to complete the requested EM.

As shown in FIGS. 19, 20 and 22-26, EM faceplate 108 includes field 344 that displays information depending on which of the buttons below field 344 an operator selects. As indicated in FIG. 20, the operator last selected fault button 346. In response, EM faceplate 108 displayed all potential faults and highlights those potential faults that are in a fault condition. As shown in FIG. 20, fault indicator 348 is green indicating that none of the potential faults are in the fault condition. If one (or more) of the potential faults were in the fault condition, fault indicator 348 would be red.

When an operator selects CM button 350 as shown in FIG. 20, EM faceplate 108 pulls all CM's associated with the relevant EM and displays them in field 344 as tiles 352 that include the CM name from columns 310 of acquire table 256. The status of each CM is indicated by indicator 354 (green for acquired and red for not-acquired).

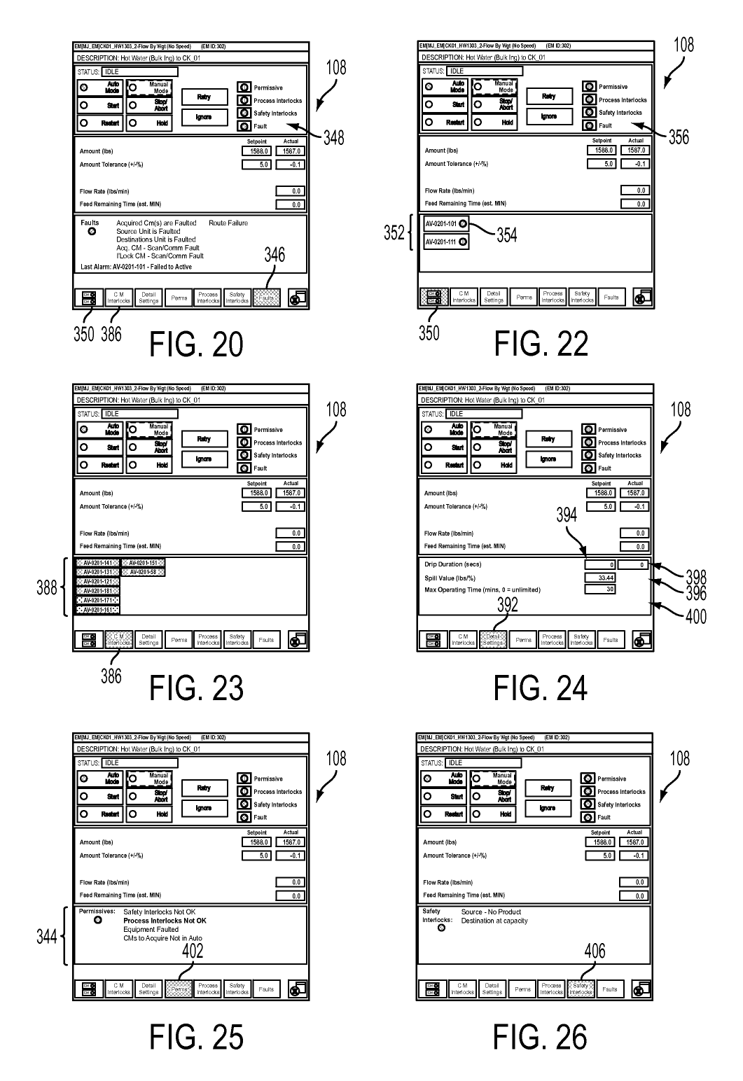

During operation of an EM, an operator may notice that fault indicator 356 is green when there is no fault or is yellow indicating that the EM has a fault. In response to indicator 356 being yellow, the operator can select fault button 358 and EM faceplate 108 brings up all potential faults in field 344 as shown in FIG. 20. Assuming that the “acquired CM(s) are Faulted” is highlighted indicating the there is an issue with the CM to be acquired, the operator may then select CM button 350 and EM faceplate 108 will bring up CM tiles 352 with indicator 354 indicating which CM have been acquired and which have not as shown in FIG. 22. If indicator 354 for tile 352 is yellow, the operator knows which CM in the fault condition.

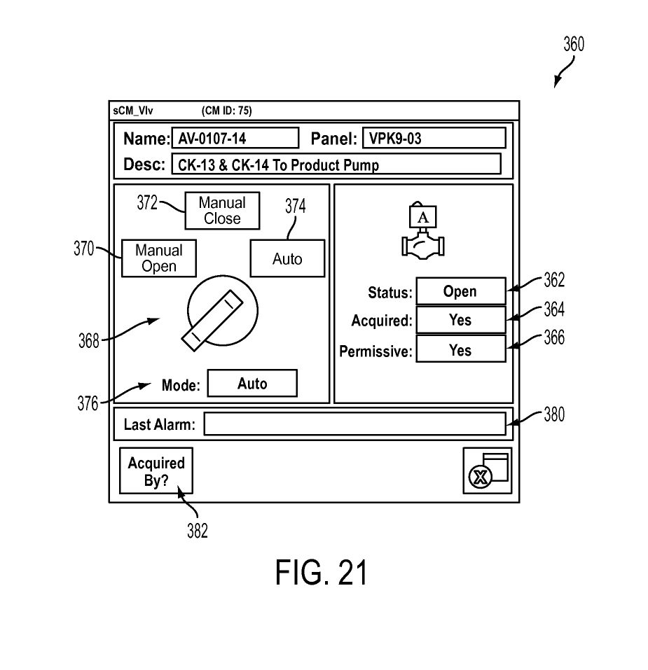

In response, the operator can select this tile 352, which opens a valve faceplate similar to valve faceplate 360 shown in FIG. 21. Valve faceplate 360 displays information from operational configuration database 84 for each respective valve, such as the ID from column 232 of CM table 210, the name from column 226, its panel location from column 240, and its description from column 238. Each respective valve provides its status to PLC 82 so that faceplate 360 displays its status in status field 362. Acquired field 364 indicates if the valve has been acquired and permissive field 366 indicates its status, if it is a permissive device, which is explained in greater detail below.

As shown in FIG. 21, valve faceplate 360 includes a virtual switch 368 that allows an operator to “manually” control the valve. For example, the operator can select manual open button 370 that will override instructions 90 and open the respective valve, manual close button 372 that will override instructions 90 and close the respective valve, or auto button 374 that will default to the position requested by instructions 90. Mode status field 376 and the position of dial 378 both indicate the mode of control of the respective valve (ex. auto, manual open, or manual closed). Last alarm field 380 indicates the last time that the respective valve was in an alarm condition in need of repair or otherwise.

As example of the above, during start up of EM 318 shown in FIG. 1, EM 314 was in operation and an operator was informed of a CM acquire fault by EM faceplate 108 for EM 318. In response, the operator selected CM button 350 and EM faceplate 108 for EM 318 pulled up CM tiles 352 for valves, 44, 52, 60, 68, 70, 72 in field 344, two of which (valves 68, 70) indicate the CM fault or failure by their indicators. In such a circumstance, the operator may select the CM tile 352 for either valve 68, 70 that are indicating the fault. In response, valve faceplate 360 for the selected CM (ex. valve 68) appears. Suspecting that the fault or route failure was caused by a necessary valve 68 having already been acquired by EM 314, the operator may select “acquired by” button 382 on CM faceplate 360 shown in FIG. 21 for valve 68. In response, PLC's 82 pull from operational configuration database 84 that EM 314 currently has acquired valve 68 from a table that stores which EM has acquired valve 68, if any. Knowing that EM 314 has acquired valve 68, an EM faceplate 108 for EM 314 is created and displayed in response to selecting acquired by button 382. With EM faceplate 108 for EM 314 pulled up, the operator can determine how much longer EM 314 will run by viewing remaining time field 384. If the operator determines that it is more important for EM 318 to start before EM 314 finishes, the operator can place EM 314 in manual mode and put EM 314 on hold, which frees up valve 68 (and valve 70) for use by EM 318. After EM 318 is finished, the operator can restart EM 314 assuming any necessary cleaning has occurred.

Referring now to FIG. 23, an operator has selected CM interlock button 386. In response, EM faceplate 108 shows CM interlock lock tiles 388 based on data pulled from interlock table 258 in a manner similar to pulling up CM acquire tiles 352 discussed above. Similar to CM acquire tiles 352, CM interlock tiles 388 may include indicators indicating their fault status. If field 344 indicated an interlock fault when displaying faults (see FIG. 20), the operator could select CM interlock button 386, select the CM interlock tile 388 indicating a fault, view the CM faceplate 360 presented in response to the selection, and press acquired by button 382 to determine which, if any, EM has interlocked or acquired the respective CM in a manner similar to that discussed above for an acquired CM fault.

Referring to FIG. 24, an operator has selected a detail setting button 392 and EM faceplate 108 has populated field 344 with details relating to the respective EM. After an EM shuts off its respective pump, if any, and closes its respective valves, if any, material often continue to flow into the destination unit. For example, after EM 314 ends, brine in the pipe 41 between valve 64 and cook kettle 38 will continue to flow into cook kettle 38. Database 84 populates drip field 394 with the length of time (in seconds) of this continued flow or drip and the spill/drip amount in spill field 396. Initially, EM table 254 may be populated for the drip time and drip amount. The actual drip time is provided in actual drip time field 398.

During operation of an EM, these values are refined as PLC's 82 monitor the performance of plant 10. For example, PLC's 82 may monitor the time between EM 314 ends and an instrument associated with tank 38 stops detecting meaningful addition of brine. Similarly, PLC's 82 may measure the amount of brine detected by the instrument that is added to tank 38 during the time after EM 314 ends. PLC's 82 may consider the value of the drip time and spill amount already stored in database 84 with the observed values and utilize averaging or some other formula to place the values stored in database 84 with these calculated average to avoid drastic changes. Furthermore, an operator may update these values by manually updating database 84.

As mentioned above, most EM's have a set maximum run time stored in EM tables 254 or elsewhere. If an EM takes longer than this amount of time to complete its function, PLC's 82 will automatically stop the EM and send an error message to an operator indicating that the EM ran past its maximum run time. The maximum run time is displayed in max run time field 400, which a control system engineer/operator populated into EM table 254 or elsewhere.

Referring to FIG. 25, if the operator selects permissive button 402, EM faceplate 108 displays the status of any permissive components in field 344. Permissive components, if any, are components that are not actively controlled by PLC's 82, but should be in a given state or position in order for the respective EM to perform properly. For example, plant 10 may include a manually operated valve that must be in a position for an EM to function properly. Such a valve may include a proximity switch (not shown) indicating the position of such a valve. During programming, EM table 254 is populated with any such permissive components for each EM. Before operation of the respective EM, PLC's 82 will check the position of the permissive valves, if any. If a permissive component is not in the proper status, EM faceplate 108 will indicate a fault in field 344. A permissive component table (not shown) may be provided listing all permissive components. The PLC 82 that receives information regarding the status of the permissive component (ex. feedback from a proximity switch), a description of the permissive component, etc.

Referring to FIG. 19, if the operator selects process interlock button 404, EM faceplate 108 displays the status of any processes that must be interlocked or verified before an EM is allowed to run, if any. If a process or feature is not verified or interlocked, EM faceplate 108 will indicate a fault in field 344. For example, if a destination unit has no capacity, field 344 will indicate an error.

Referring to FIG. 26, if the operator selects safety interlocks button 406, EM faceplate 108 displays the status of any safety features that must be interlocked before an EM or all EM are allowed to run. For example, cook kettles 34, 36, 38 may include burners with gates to prevent plant employees from entering the area of the burner during operation. If any of the gates are not in the closed position blocking access to the burners during operation, PLC's 82 will detect a safety interlock fault. If a safety feature is not engaged or activated, EM faceplate 108 will indicate a fault in field 344.

EM faceplates 108 may include a dedicated input device which may, in an embodiment, be a keyboard, mouse, trackpad, or touchscreen, and may also include a dedicated output device, which may, in an embodiment, be a computer screen, printer, or other visualization device. EM faceplate 108 may be in communication with component control system 78 via, for example and without limitation, network 88, or may be in communication with component control system 78 via another network 88, such as a radio network 88 or other wireless link. The connection between EM faceplate 108 and component control system 78 may be encrypted or unencrypted, or certain communications may be encrypted, while other communications are unencrypted. EM faceplate 108 may be hardware or software operating on specific or commodity hardware. In an embodiment, EM faceplate 108 may include a smartphone and software executed on the smartphone.

In addition to faceplates 108, 306 providing information on the status of components in plant 10, graphical representations of portions of plant 10 may also be displayed to an operator or other user. For example, a portion of a plant diagram showing cook kettle 34 for plant 10 is shown in FIG. 27. The diagram provides graphical representations of all pipes feeding and draining cook kettle 34, valves controlling these pipes, pumps, motors, etc. in the vicinity of cook kettle 34. The full diagram of plant 10 shows the other components of plant 10.

The diagram portion and the full diagram includes the name of the units in name fields 412, the current temperature of the units in temperature fields 414, the current level of the units in fill fields 416, the speed of agitators operating in the unit in RPM fields 418, 420, and the recipes under way from scheduling control system 76 in status fields 422. The diagram further includes name fields 424 for valves, pumps, motors, etc. indicating the names of these CM's. Name fields 412, 424 are filled with the respective names populated into database 84. The other fields on the diagram are filled with information provided by PLC's 82, instruments, from database 84 or otherwise.

As discussed above, certain faults may occur that inhibit the use of CM's, EM's, etc. The diagram further includes alert tiles 426 that flash when a fault impacts the unit or other component of plant, such as cook kettle 34 shown in FIG. 27. When an alert tile 426 is flashing, an operator may select it to obtain additional information regarding the fault.

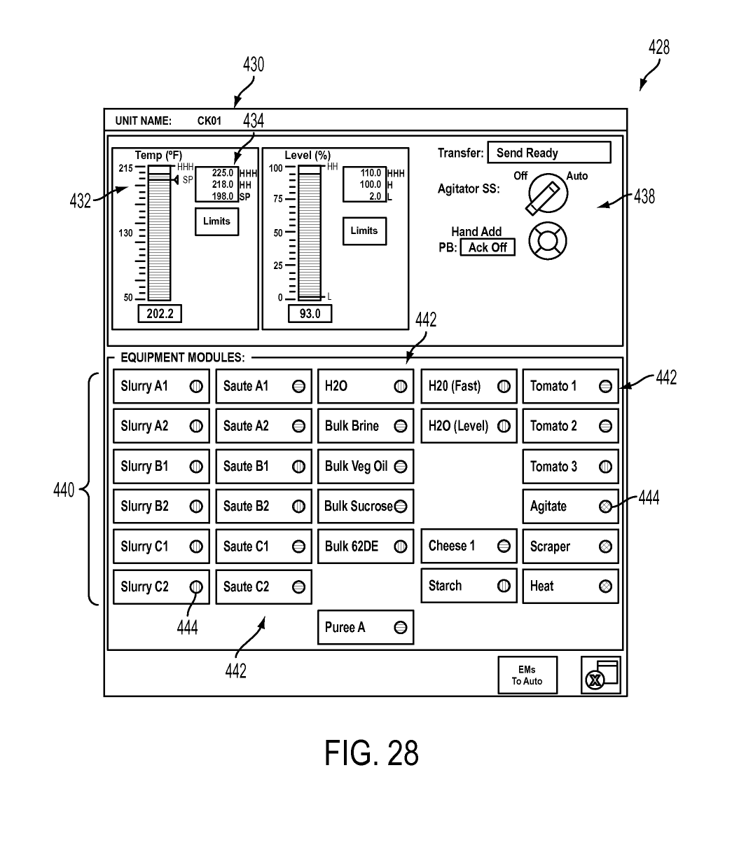

In response to the selection, PLC's 82 display a unit faceplate 428 as shown in FIG. 28. Unit faceplate 428 includes a name field 430 displaying the name of the unit from database 84, a thermometer 432 displaying the temperature of the unit, a setpoint field 434 displaying setpoints of the unit, a level indicator 436 displaying the current fill level of the unit, an agitator control switch 438 allowing “manual” control of the agitators, and a EM module field 440 including EM tiles 442 for some or all of the EM's that relate to the unit. For example, all EM's that feed into the unit may be listed as EM tiles 442. All EM's that operate on or within the unit may be listed as EM tiles (ex. agitate, scraper, heat). Each EM tile 442 includes an indicator 444. Further, for any EM's causing a fault, its EM tile 442 will flash. The operator may select any of EM tile 442, which will cause the EM faceplate 108 for that EM to be displayed. As discussed above, the operator may use the EM faceplate 108 to further investigate the fault and display any CM faceplates 306 associated with the respective EM.

Referring again to FIG. 27, each CM may include a status indicator 446 that indicate the status of the respective CM. For example, some CM status indicators 446 may show an “A” indicating that the CM has been acquired by an EM or an “I” indicating that the CM has been interlocked by an EM. For additional details on the CM, an operator may select the CM graphic. In response, PLC's 82 may display a CM faceplate for the selected CM.

According to one embodiment of the present disclosure, manufacturers of CM's or other parties may design faceplates for equipment that they or others manufacture or supply. Along with these faceplates, they may provide proposed changes to configuration database 84 to support the provided faceplate.

As mentioned above, the components of plant 10 need periodic cleaning To accomplish this cleaning, database 84 is populated with cleaning EM's. For example, database 84 may include an EM for cleaning the unit shown in FIG. 27. As shown, this unit includes multiple valves that feed materials (ingredient, heating or chilling water, etc.) into or around the unit. To clean the unit, the cleaning module is populated with all the necessary valves, agitators, pumps, etc. that must be operated to clean the unit.

In order to properly clean the unit, a sufficient flow rate and temperature of cleaning agent (acid, caustic, water, etc.) must be forced through the various components. During cleaning of valves, the valves open and close repeatedly with the cleaning agent flowing through the valve to thoroughly clean the valve seats, etc. To maintain the necessary flow rate, not all of the valves of the unit may be cleaned at the same time. Rather, many of the valves must remain closed while other valves are being cleaned. Once valves are cleaned, they are closed while some or all of the other previously closed valves are cleaned. To control the timing of the cleaning and closing of the valves, the sequence of the cleaning is populated into database 84. For example, a group of valves may be indicated as the valves to be cleaned in a first cleaning stage, a second group of valves may be indicated as the valves to be cleaned in a second cleaning stage, etc. Instructions 90 include cleaning instructions that refer to these groupings in database 84 to control the cleaning sequences. Some or all of the grouping may include a single valve or other component.

During the cleaning EM to avoid excessive water hammering, it is preferable to keep the pumps running during the transition between one group of valves to be cleaned and the next group of valves to be cleaned. To further avoid water hammering, the cleaning of groups of valves may overlap slightly to that flow paths for the cleaning agent are always available (i.e. all of the valves of the cleaning EM are not closed at the same time while the pump is running).

In an embodiment, component control system 78 creates and stores one or more log files (not shown) related to the operation of component control system 78, the configuration database 84, and/or the operation of the component control system 78 may create log file entries to document a change to component control system 78, the configuration database 84, or the transmission or receipt of information from one or more of PLC's 82 or faceplates. In an embodiment, the changes made to component control system 78 and/or the configuration database 84 may be stored with the log files, or may otherwise be associated with the log files. The changes may be stored so that the changes may later be analyzed or may be made to component control system 78, allowing a “rollback” of component control system 78 to one or more points in time. The log files and/or the changes may also be captured for audit purposes or for verification or review by a regulatory authority or other entity.

In addition to populating database 84 with “active” components, such as valves, pumps, instruments, etc., a control system engineer may populate database 84 with inactive components, such as pipes 41. When populated into database 84, additional features can be incorporated into the operation and monitoring of plant 10. For example, plant 10 can be animated to show which pipes 41 are in use and the status of each pipe (ex. being cleaned, rinsed, transferring ingredients, etc.). Furthermore, the type of ingredient that last travelled through pipes 41 can be monitored to avoid contamination from residue that might remain in pipes 41.

In a manner similar to populating database 84 with units, instruments CM's, and EM's, database 84 is populated with pipes 41. A control system engineer populates a pipe table (not shown) with a pipe name in a name column and components situated at ends of pipe 41 in respective pipe end columns. As an example, pipe 508 shown in FIG. 1 is named “valve 68 to valve 70” in the name column, the first end column is populated with “valve 68”, and the second end column is populated with “valve 70.” Although pipes 41 shown in FIG. 1 all have two ends, some pipes 41 may have more than two ends. As such, the pipe table includes enough pipe end columns for each end of the respective pipes. In another embodiment, a control system engineer determines a unique pipe name and applies that pipe name to a port of “valve 68” and to a port of “valve 70”. For example, a control engineer may choose the name “Pipe 508” and apply that name to both “valve 68” and “valve 70”. This embodiment may be more convenient but is dependent on the control engineer to determine unique pipe names.

In the case of either embodiment discussed in paragraph [118] above, step 115 shown on FIG. 5 includes population of a pipe status table in the operational configuration database 84. During operation of an instruction 90, PLC's 82 update the status of pipes 41. For example, the pipe table may further include a status column and a material column indicating the respective status and type of material to pass through pipes 41. For example, after initial commissioning of plant 10, all of pipes 41 are cleaned with water. As such, the status of pipe 508 in the status column “empty” and the material column is populated with “water” for pipe 508. Next, EM 314 is activated to supply brine from tank 18 to cook kettle 38. Knowing that valves 68 and 70 are acquired and used during activation of EM 314 to deliver brine, PLC's 82 can determine that pipe 508 is used during EM 314 by referencing the end columns of the pipe table. During operation of EM 314, the status of pipe 508 is set at “full” in the status column and the material column is populated with “brine” indicating the last material to pass through pipe 508. Upon completion of EM 314, PLC's change the status of pipe 508 from “full” to empty and the material column remains unchanged with “brine.”

According to one embodiment of the present disclosure, PLC's 82 determine the status of each pipe 41 by checking the status of each end of a pipe. An end of a pipe 41 is considered active if a CM, unit, instrument, etc. is open toward a source, such as tank 12, 14, 16, 18. An end of pipe 41 is otherwise considered non-active. If a pipe 41 has an active end, its status column changes to full and its material column changed to material of the source. Once the active end is no longer active, the status column changes to empty.

Using this pipe data stored in database 84, plant 10 can be animated to shown the flow of materials through plant 10 and the status of pipes 41. For example, all pipes 41 shown in FIG. 1 may be graphically represented in an image. The color or other features of the graphical representation of pipes 41 change as that status and/or material that last past through pipes 41 change. For example, as described above, pipe 508 was cleaned with water during commissioning. During this cleaning, the status of pipe 508 was “full” and the last ingredient to pass through pipe 508 was the water used to clean pipe 508 as determined by valve 68 being open/active toward water tank 28.

During this cleaning, pipe 508 is shown in solid blue in the graphic indicating that pipe 508 is full of water. For example, as shown in FIG. 27, pipes 41 are shown in two dimensions with shading indicating they are round and providing a three dimensional appearance. When shown as full, the entire pipe is shown in the given color.

After cleaning, the status of pipe 508 changes to empty and pipe 508 is shown with blue “residue” because its pipe status changed to empty, but it likely actually contains some residue of the last material to pass through. For example, the entire pipe is no longer shown in the given color, but only the interior surface of the pipe is shown in the given color (i.e. the inner lining of the pipe is shown in blue and the center of the pipe is shown in base color, such as white, etc). Other materials that pass through plant 10 are indicated with other colors. For example, acid may be shown as green, caustic (ex. soap) may be shown as red, inert ingredients (ex. brine) may be shown as yellow, allergens (ex. peanut oil, peanuts, pine nuts, milk, eggs, etc) may be shown as orange. Individual ingredients may also be given their own colors or feature (ex. intermittent colors, alternating colors, etc.).

During the next use of pipe 508, database 84 is updated to change the status in the status column to “full” and the material in the material column to whatever material passed through pipe 508. For example, if EM 314 is the next EM to operate, the material in the material column for pipe 508 changes to brine. In response to these changes, the graphic changes so that pipe 508 is shown in solid yellow. When EM 314 concludes, the graphic changes to yellow residue to indicate to an operator that pipe 508 is currently not in use and contains inert residue.

The graphic illustrated in FIG. 1 is updated periodically to simulate real-time operation of plant 10. These updates may be based on a time function or a triggering event. For example, PLC's 82 may poll database 84 for the status of pipes 41 and the material in pipes 41 every second (or any other time interval) or PLC's 82 may poll database 84 after the completion of any EM.

In addition to supporting the graphics, PLC's 82 may use database 84 to guard against contamination of batches of food products, pharmaceuticals, etc. As mentioned above, database 84 maintains the last material in pipes 41 in the material column. According to one embodiment of the present disclosure, the materials routed through plant 10 are classified in a hierarchy based on their biocompatibility. For example, in a five class hierarchy, water may be classified as a 5, inert ingredients (ex. brine, tomato juice, etc.) as a 4, potentially moderately bio-incompatible ingredients (ex. milk, wheat, etc.) as a 3, potentially severely bio-incompatible (ex. peanuts, peanut oil, pine nuts, walnuts, hazelnuts, almonds, eggs, poultry, etc.) as a 2, acid and caustic as a 1. Some or all of the classes may have subclasses. For example, class 2 may be broken into as 2A for peanuts and peanut oil; 2B for pine nuts, walnuts, hazelnuts, almonds; 2C for eggs and poultry; etc.

PLC's 82 populate database 84 with the class (or subclass) of the last material to run through pipes 41, pumps (ex. pump 20), and any other components through which materials run. During each EM phase that transports ingredients, PLC's 82 check the classes of material to run through each CM, pipe 41, and any other component along the route of the EM. For example, during EM 314, PLC's 82 initially check the material classes that last ran through valves, 66, 68, 70, 62, 64 and pipes 41 (including pipe 508) that extend between tank 18 and cook kettle 38. If PLC's 82 detect an unacceptable class along the route, PLC's 82 will old the EM and alert the operator via HMI faceplate 108.

In an example, pipe 514 last delivered peanut oil from tank 16 to cook kettle 36. As such, PLC's classify pipe 514 as class 2A. Next, scheduling control system 76 requests that brine be delivered from brine tank 18 to cook kettle 38 using EM 314. PLC's 82 check the material classification of all components along EM 314 and determine that pipe 514 has classification 2A, which is a lower biocompatibility than brine (biocompatibility classification of 4). As such, PLC's 82 place EM 314 on hold until pipe 514 is cleaned by suitable EM's. After rinsing with water, PLC's 82 change the material status of pipe 514 to 5. PLC's 82 recheck the material classification of all components along the route for EM 314 and determine that the classification are acceptable (ex. all have classification 4 or higher). In response, PLC's 82 deliver brine from brine tank 18 to cook kettle 38.

In an embodiment, component control system 78 may review the EM's that the user specified, and may make suggestions for a more optimal route, or a more optimal collection of CM's to use to accomplish the same task. For example, if the user wishes to move product from a first tank to a second tank, and specifies a collection of valve CM's to use to transfer the product, component control system 78 may suggest an alternate collection of valves that have a shorter route, or that may be used while a different EM is running, to accomplish the same task in a shorter time or while one or more other EM's are executing.

In another embodiment, component control system 78 may include a graphics feature that visualizes units, instruments, CM's, etc. and allow a control system engineer to populate configuration database 84 visually. For example, CM's and other plant components may be displayed in a manner similar to FIG. 1. By the act of building this display, the control system engineer builds many of the configurations of configuration database 84. For example, by including visual representations on the display, the system control engineer creates rows in configuration database 84 for each physical element, e.g. valve, pump, tank, pipe, instrument, etc., and gives those elements unique names.

Initially, a control system engineer may start with a pre-defined sample plant layout that includes graphical representations of generic units (sources and destinations), CM's (valves, pumps, etc), instruments, etc. presented on a display. Such a pre-defined plant layout may be based on the P&ID drawing generated by a process engineer. Different graphical representations for each unit, instrument, and CM class may be displayed or more generic graphical representations for units, instruments, and CM may be displayed. For example, every unit may have the same graphic representation.

Using the displayed, pre-defined sample plant layout, the control system engineer selects each graphical representation. For example, if the components of FIG. 1 are displayed, the control system engineer may select tank 12 with a computer mouse, stylus, etc. In response to the selection, a respective table for the type of selected component is displayed. In the present example, unit table 138 is displayed allowing the control system engineer to label, classify, and otherwise define the perimeters of tank 12. Once the graphic is classified, the graphic may change to be more specific to the classification. For example, source tank 12 and cook kettle 34 may initially be shown using the same graphic (ex. a box). After being classified, the graphic for tank 12 may change from a box to that shown in FIG. 1 (i.e. a tank) and the graphic for cook kettle 34 may change from a box to that shown in FIG. 1 (i.e. a vessel). If the initial graphic shown in the pre-defined layout was specific to a particular class, the control system engineer does not need to classify the component.

The control system engineer continues selecting and naming, classifying, and otherwise defining the parameters of each graphic shown in the pre-defined layout. If additional components are required, the control system engineer may select an icon from a pull down menu for a component (unit, instrument, CM, pipe, etc.) and “drag and drop” the icon to a desired location on the layout. Valves, pumps, etc. may be connected with graphical pipes by selecting the two components to be connected after selecting a pipe icon. Once connected, the pipe table discussed above is automatically populated to include the components connected to the pipe in the end columns of the pipe table discussed above. Further, the pipe table may open allowing the control system engineer to name, size, and otherwise populate the pipe table.

If unnecessary components are displayed in the pre-defined layout, the control system engineer may select and delete the unnecessary component. According to an alternative method, the control system engineer starts with an empty plant layout and populates the plant layout with graphical representations of the components.

The layout may be subdivided into groups, each group corresponding to a display on a human-machine interface display. Such designation may be indicated by drawing of a stretchable rectangle made to encompass all items of a HMI display or by other means. By designating which items of equipment are to be on which HMI display those displays may be created and/or validated. For example, referring to FIG. 1, a user may designate tanks 28, 30, and 32 along with instrument 26, valve 43 and pump 22 to be on one display. Tank 12, instrument 24 and pump 20 may be another display.

To create EM's, a user may select components on the display to populate definitions, acquire, and interlock tables 254, 256, 258. In the example of a delivery EM, a user may select start and destination units (ex. tank 12 and cook kettle 34) on the display to populate portions of definitions table 254. The user may then select CM's to acquire to populate acquire table 256. For example, the control system engineer may select the graphics for valves 42, 44, 46, 48 for EM 80. Similarly, the control system engineer may then select CM's to interlock to populate interlock table 258. For example, the control system engineer may select the graphics for valves 43, 50, 52, 54, 56 for EM 80.

Each selected graphic has an assigned name/ID for its represented component. When selected, the respective columns (ex. source column 288, destination column 292, CM acquire columns 310, interlock columns 324, etc.) of tables 254, 256, 258 are automatically populated with the assigned name/ID of the selected, graphically represented components.

According to one embodiment, components for EM's are automatically recommended rather than individually selected. For example, a control system engineer may select a source unit and a destination unit for a deliver EM and client 86 (or PLC's 82) may create an EM to accomplish the delivery task. For example, and without limitation, the user may designate the source as a first tank (ex. tank 18) and the destination as a second tank (ex. cook kettle 38), and client 86 may select one or more valves between tank 18 and second tank 38 to allow product to flow from first tank 18 to second tank 38. Client 86 may then create an EM using the CM's it has selected to move the product from first tank 18 to second tank 38.

During the recommendation process, client 86 determines which combinations of CM, pipes, etc. provide paths between first tank 18 and second tank 38. To determine the possible paths, client 86 “branches” out through possible exit points from a source unit and the possible entry points to a destination unit until client 86 finds one or more overlapping exit and entry points.

In an example including source tank 18 and destination tank 38, client 86 first determines the possible first level exit points from source tank 18 (i.e. through valve 66) and the possible first level entry points into destination tank 38 (i.e. into valve 64). Next in determining the branching, client 86 determines the second level exit points by determining possible exit points from all first level exit paths. For example, valves 68, 58 provide exit points for the first level exit point provided by valve 64. As such, valves 68, 58 are second level exit points for source tank 18. Similarly, valves 56, 62, 72 are determined to be second level entry points for destination tank 38.

Client 86 continues to determine further levels of exit points and entry points until it finds overlap between the exit and entry points. For example, while determining the next level of exit and entry points, client 86 recognizes that valves 60, 70 are both third level exit and entry points. Client 86 then determines the first and second level exit points that lead from source tank 18 to the overlapping points (valves 60, 70) to define exit paths and the first and second level exit points that lead from overlapping points (valves 60, 70) to destination tank 38 to define entry paths. In the present example, two paths from source tank 18 lead to valve 60 (valve 66 to valve 58 to valve 60 and valve 66 to valve 68 to valve 60) and one path leads to valve 70 (valve 66 to valve 68 to valve 70). Similarly, one path leads to destination tank 38 from valve 60 (valve 60 to valve 62 to valve 64) and two paths lead to destination tank 38 from valve 70 (valve 70 to valve 62 to valve 64 and valve 70 to valve 72 to valve 64). In various combinations, these paths provide four possible routes from source tank 18 to destination tank 38 using different combinations of valves 58-72.

According to one embodiment, after finding a possible route, client 86 stops searching for possible routes. According to another embodiment, after finding a possible route, client 86 continues to search for additional possible routes using additional levels of exit and entry points. When searching for additional possible routes, client 86 may continue to search a set number of levels (ex. two more levels that include levels four and five in the example above) or client 86 may stop searching once it determines that additional best fits for a criteria are not being identified as discussed below.

After client 86 has determined one or more possible routes from source tank 18 to destination tank 38, one of the routes needs to be selected for the delivery EM. According to the present disclosure, client 86 recommends one of the routes based on one or more criteria. For example, according to one embodiment, the length of pipes 41 as stored in the pipe table. Based on this, client 86 can determine which of the possible routes is the shortest and suggest the shortest route to the control system engineer for selection or automatically select the route. According to another embodiment, the size or diameter of pipes 41 is also populated into the pipe table. Based on this and the length of pipes 41, client 86 can determine which of the possible routes has the smallest volume to minimize spill and suggest to smallest volume route to the control system engineer. In the process of searching for additional possible routes discussed above, client 86 may stop searching for routes when the additional routes are no longer better matches for the selection criteria. For example, if the additional possible routes are all longer that one of the already identified routes, client 86 may stop search for routes. In another embodiment, several routes may be retained with different “costs” or priorities so that PLC 82 might choose one of several routes at execution time.

As discussed above, pipes 41 can be animated during operation of plant 10. Using a similar animation process, pipes 41 of suggested routes for delivery EM's can also be animated for the control system engineer to review. For example, if client 86 selects the route defined by valves 66, 68, 70, 62, 64 for delivery from source tank 18 to destination tank 38, client 86 may highlight pipes 41 between these valves 66, 68, 70, 62, 64 and source and destination tanks 18, 28 to visually show the control system engineer the suggested route. This highlighting may be with colors, hashing graphically displayed pipes 41, etc. The control system engineer can then select the suggested route if acceptable.

If the control system engineer does not believe the suggested route is acceptable or he would like to additional route options, the control system engineer can request that client 86 display the next best route according to the predetermined criteria. Furthermore, the control system engineer can select a portion of the highlighted, suggested route and change the course of the suggested route by “dragging” the selected portion of the route to another pipe. For example, if the control system engineer would prefer to avoid valve 70 in the above example, the control system engineer could select the highlighted portion of the route over valve 70 and drag it to another suitable location, such as valve 60. In response, a portion of the highlighting changes from between valves 68, 70, 62 to between valves 68, 60, 62.

After the control system engineer accepts a route for the delivery EM, client 86 automatically populates database 84 with the information related to route. For example, client 86 populates columns 288 and 292 of EM definitions table 254 with the source and destination that the control system engineer initially selected. Client 86 automatically populates columns 310 of acquire table 256 with the valves to be acquired (ex. valves 66, 68, 70, 62, 64). Client 86 automatically populates columns 324 of interlock table 258 with suggested valves to be interlocked. Client 86 may determine which valves to interlock by determine which valves feed into or out of the acquired valves. For example, client 86 can determine that valves 54, 60, 64, 70 feed into or out of valve 62 because they share pipes 41 with valve 54. Of these valves, client 86 also knows that valves 64, 70 are to be acquired. As such, they do not need to be interlocked. As a result, only valves 54, 60 are added to interlock table 258. If a valve is already added to interlock table 258, client 258 knows not to add it again.

On occasion, a CM of an EM may not be available because it is being serviced or may be in use by another EM. For example, valve 44 of EM 80 may be under repair. According to the present disclosure, component control system 78 will automatically suggest or implement an alternative route to avoid the CM (ex. valve 44) that is not available.

In the above example, valve 44 of EM 80 is not available. Knowing that valve 44 is not available, component control system 78 will “branch” from valve 42 (the valve immediately before valve 44 along the initial route of EM 80) and valve 46 (the valve immediately after valve 44) without using valve 44. For example, component control system 78 will determine that valve 50 is the next available exit point from valve 42 and that valve 54 is a next available entry point to valve 46. Later, component control system 78 will determine that valve 52 is a common exit point from valve 50 and entry point to valve 52 in manner similar to that described above for client 86 suggesting EM routes. With this, component control system 78 has determined that valves 50, 52, 54 and the associated pipes 41 provide a route around valve 44 between valves 42, 46. As such, component control system 78 may suggest this as an alternative route to the operator or it may automatically change the route of EM 80.

As mentioned above, scheduling control system 76 may request that component control system 78 control multiple EM's as the same time. On occasion, these EM's will have overlapping CM's, instruments, etc. For example scheduling control system 76 may request that EM 80 and EM 318 operate at the same time. Because EM's 80, 318 share common CM's (ex. valve 44) and CM's required by one EM may be interlocked by another EM (ex. valve 42 may be interlocked by EM 318 when EM 80 attempts to acquire valve 42), component control system 78 will not allow the second in time EM to start as discussed above.

According to one embodiment of the present disclosure, component control system 78 will automatically suggest or implement an alternative route to solve the overlap in components between EM's. According to the present disclosure, if component control system 78 detects such a conflict between EM's, it automatically seeks an alternative route in a manner similar to that discussed above for suggesting routes during initial population of definitions, acquire, and interlock tables 254, 256, 258. In the above example, EM 80 conflicts with simultaneous operation of EM 318. Detecting this conflict, component control system 78 knows that valves 44, 52, 60, 68, 70, 72 are not available for use because they have been acquired. Similarly, component control system 78 knows that other valves have been interlocked. However, for ease of explanation in the below example, the fact that interlocked valves are also not available is ignored.

Knowing which valves are acquired, component control system 78 will “branch” from valve 42 (the valve immediately preceding conflict valve 44 along the initial route of EM 80) and from tank 34 without using any acquired valves as exit and entry points as discussed above. Because there is no route between valve 42 and tank 34 that does not use any one of valves of EM 318, component control system 78 does not suggest an alternative route and it waits until EM 318 is complete to begin EM 80. However, if plant 10 included a route that went around EM 318, component control system 78 would automatically suggest the route. For example, if plant 10 included a pipe (not shown) that extended from valve 50 to valve 54, component control system 78 would re-route EM 80 through this pipe to avoid overlapping valve 44.

According to another embodiment of the present disclosure, component control system 78 will permit certain CM's to be used simultaneously by multiple EM's. For example, EM 80 and another EM (“Second EM”) may both require the use of valve 42 and pump 20 at the same time to deliver brine to kettle 34 and other kettle (ex. kettle 38). Assuming that instruments at kettles 34, 38 determine how much brine has been delivered to each respective kettle 34, 38, valve 42 may be open and pump 20 operating while brine is delivered simultaneously to each kettle 34, 38.

Assuming that EM 80 starts before Second EM and neither pump 20 or valve 42 are acquired or interlocked, EM 80 will start as normal and database 84 will indicate that pump 20 is on and valve 42 is acquired by EM 80. When Second EM starts, component control system 78 will “fib” to itself and indicate that valve 42 is not acquired, when it actually is. Because Second EM has been told a “fib,” it believes that valve 42 is available and it acquires valve 42 and continues to run.

As mentioned above, component control system 78 include CM manager 454 that communicates between PLC's 82 that contain EM instructions 448 and CM instructions 450. According to the present disclosure, CM manager 454 is the portion of component of control system 78 that fibs about the status of certain CM's, such as valve 42 discussed above. During population of database 84, certain CM's are designated as CM's that may be shared between EM's. If such as CM, such as valve 42, is designated as a sharable CM (ex. column 236), database 84 is populated with data indicating which EM's may share or simultaneously use the same CM. For example, valve 42 will be indicated as a sharable CM and that EM 80 and Second EM may use valve 42 at the same time. When Second EM request the use of valve 42, CM manager 454 checks database 84 to determine if valve 42 is sharable and which EM's can share it. When CM manager 454 detects that valve 42 is sharable between EM 80 and the Second EM, it indicates to EM instructions 448 that valve 42 is not acquired, even though valve 42 is acquired by EM 80. As such, EM instructions 448 proceed with the operation of the Second EM. If EM 80 finishes its task before the Second EM, CM manager 454 no longer fibs because valve 42 is no longer acquired by another EM. When the Second EM finishes its task, CM manager 454 indicates to database 84 (or a respective database 452) that valve 42 is no longer acquired.\

According to the present disclosure, PLC's 82 are one type of automation controller suitable for use with the present disclosure. As used herein, the term “automation controller” means a controller that monitors discrete and/or analog I/O signals, processes user defined logic that is compiled or not compiled, and controls other discrete and/or analog I/O signals. Automation controllers may include those manufactured and marketed for stand-alone use such as those marketed by Rockwell Automation, Siemens, Schneider and many others including PLC's 82 or Programmable Automation Controllers (PACs). Automation controllers also include those not marketed for stand-alone use such as those marketed as part of systems marketed by Emerson, ABB, Invensys and many others which may be commonly known as distributed control systems (DCSs).

The term programmable logic controller (or PLC) as used herein means a device that satisfies the requirements of IEC 61131-3. According to IEC 61131-3, a PLC must support one or more standard programming languages, such as ladder diagram (LD), function block diagram (FBD), structured text (ST), instruction lists (IL) and sequential function chart (SFC). According to the present disclosure, PLC may also support non-standard programming languages, such as instructions 90 stored in the memory of PLC's.

The term controller as used herewith means automation controller, traditional computers, and other control devices. They may include emulations of automation controllers as otherwise defined herein and other software controllers designed to run on traditional computer or other hardware which function as automation controllers as otherwise defined herein.

According to the present disclosure, instructions 90 in the memory of PLC's 82 include compiled code and non-compiled (or source) code resides in database 84. The compiled code is generated from source code before it is uploaded into the memory of PLC's 82 and normally pulls data from operation configuration database 94 to determine the parameters of a requested EM (ex. which CM's to use, etc.). The compiled code is compiled outside of PLC's 82, uploaded to PLC's 82, and stored in the memory of PLC's 82 before any requests are made that require use of the compiled code.

PLC's 82 may include an interpreter that interprets or executes the non-compiled code pulled from database 84. The interpreter is preferably complied code that is part of instructions 90 stored directly within PLC's 82. Preferably, the interpretation of the non-compiled (or source) code occurs just after a request is made that requires use of the non-compiled code. Each time the non-compiled code is required for a task, the interpreter re-interprets the non-compiled code in the respective PLC 82.

As a result of relying on compiled code and non-compiled code with a PLC 82, come of the code (ex. the compiled code) will have been interpreted outside of PLC's 82 and communicated over network 88 and other code (ex. the non-compiled) code will not have been interpreted before being sent over network 88. All things being equal, the compiled code stored in the memory of PLC's 82 can be run faster than non-compiled code stored in the memory of PLC 82.

As mentioned above, the non-compiled code resides in operational configuration database 94. During operation, compiled portions of instructions 90 pull information from database 94 to complete a task. A portion of this information may include non-compiled code, such as text strings or source code. For example, during execution of a given EM, instructions 90 pull information from database 84. During populating of database 84, the control system engineer populated a field of a CM, such as an agitator, in database 84 with non-compiled text string or source code. This source code is later pulled from database 84 during running of the EM. The compiled code of the interpreter interprets this non-compiled source code to make a logic-based conclusion. Thus, by placing source code in a field of database 84, unique source code may be provided for each CM, EM, etc.

According to another aspect of the present disclosure, the non-compiled code stored in database 84 of memory of PLC's 82 can be added or modified over network 88 or otherwise without disabling the respective PLC 82 storing the non-compiled code. Whereas, if the compiled code is added or modified, the respective PLC 82 would be disabled until the modification is complete. For example, if compiled code requires an update, the respective PLC 82 (or all PLC's 82), must be disabled so they no longer send outputs to CM's. As a result, the CM's operated by the PLC's 82 receiving the update are likewise disabled. For many plants 10, this will require shutting down one or more production lines. However, the non-compiled code can be updated by updating database 84 without the respective PLC 82 being disabled so that the respective PLC 82 can continue providing outputs to CM's. As such, the production line 10 need not be shut down, but can continue producing products.

According to one embodiment of the present disclosure, the non-compiled code is specific to a particular CM and the compiled code is generic to a particular glass of CM's. For example, non-compiled code may be provided to a particular agitator during populating of database 84 and compiled code generic to all agitators is part of compiled instructions 90. As a result, the particular agitator is controlled by both compiled and non-compiled code and all the other agitators may be controlled by compiled code alone.

Providing source code to database 84 for particular CM's, EM's, etc. is not limited to the initial population of database 84. For example, during initial population of database 84, an operational circumstance of a particular CM may have been overlooked, wrong, or changes over time. To address the operational circumstance, a control system engineer or other user may modify or add a field to database 84 with non-compiled code that solves the issue. In one example, compiled instructions 90 are designed to turn on a light when all agitators are turned on. However, after initially uploading compiled instructions 90 to PLC's 82, it is discovered that it is undesirable to turn on a light in a particular agitator when a light sensitive ingredient, such as yeast, is added to kettle with the agitator. Discovering this issue, the control system engineer, writes source code that determines if yeast is one of the ingredients added to the kettle. Normally, compiled instructions 90 receives the same result (ex. “TRUE”) when inquiring as to whether or not to turn on the light. However, for this particular agitator, the result is not the same (ex. “FALSE”), because the source code determines that yeast is an ingredient in the kettle. As a result, the light is never turned on when yeast is present in the kettle of this particular agitator. Furthermore, as discussed above, the production line of plant 10 with this issue need not be turned off because the respective PLC's need updated compiled code. Rather, because operational configuration database was updated to include the new code, the production line can continue to run.

Network 88 may include one or more of: a local area network, a wide area network, a radio network such as a radio network using an IEEE 802.11x communications protocol, a cable network, a fiber network or other optical network, a token ring network, or any other kind of packet-switched network may be used. The network 88 may include the Internet, or may include any other type of public or private network. The use of the term “network 88” does not limit the network 88 to a single style or type of network, or imply that one network is used. A combination of networks of any communications protocol or type may be used. For example, two or more packet-switched networks may be used, or a packet-switched network may be in communication with a radio network.

Memory 94 discussed herein includes computer readable media. Computer-readable media may be any available media that may be accessed by one or more processors 92 of the receiving system and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by component control system 78.

As mentioned above, the feature of the present disclosure may be used in other environments other than food processing, such as discrete assembly. For example, rather than controlling a valve, component control system 78 may control a gate on a conveyor line. Rather than controlling a pump, component control system 78 may control an actuator that moves a component or an electric motor that moves a component down a conveyor line. Component control system 78 may control a nut or screwdriver rather than an agitator.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains.

1-36. (canceled)

37. A batch process manufacturing facility including:
a plurality of units containing different materials that when combined form products,
a plurality of instruments positioned to measure characteristics of the different materials, each of the plurality of instruments having an instrument identifier,
a plurality of control modules positioned to control the manipulation of the materials, each control module having a control module identifier,
a plurality of equipment modules having an equipment module identifier, and
at least one controller including at least one database and instructions including compiled code, the at least one database including the instrument identifiers, control module identifiers, and equipment module identifiers, and non-complied code, the at least one controller receives a request to manipulate a material, wherein based on the request, the compiled code of the instructions pull from the at least one database non-compiled code and interprets the non-compiled code to manipulate the material.

38. The facility of claim 37, wherein the interpreted non-compiled code is configured to receive input from at least one of the plurality of instruments and provide a result to the compiled code that is dependent upon the input, the compiled code is configured to receive the result and manipulate the material based on the result.

39. The facility of claim 37, wherein the at least one controller is configured to control the plurality of control modules based on the compiled code of the instructions and information in the at least one database, the at least one controller is configured to cease control of the plurality of control modules during altering of the compiled code and to continue control of the plurality of control modules during altering of the non-compiled code in the at least one database.

40. The facility of claim 39, wherein the altering of the compiled code of the instructions includes modifications to the compiled code and altering of the non-compiled code includes at least one of updating the non-compiled code or adding non-complied code to the at least one database.

41. The facility of claim 37, wherein the compiled code is delivered to the at least one controller over a network and the non-compiled code is delivered to the at least one controller over the network and executed directly within the at least one controller.
